(19) United States
(12) Patent Application Publication
(10) Pub. No.: US 2017/0344112 A1
(43) Pub. Date: Nov. 30, 2017

(54) GAZE DETECTION DEVICE

(71) Applicant: FOVE, INC., San Mateo, CA (US)

(72) Inventors: Lochlainn Vaughn Wilson, Tokyo (JP); Keiichi Seko, Tokyo (JP); Yamato Kaneko, Tokyo (JP); Remco Kuijer, Tokyo (JP); Harper Benjamin Scott, Tokyo (JP)

(21) Appl. No.: 15/608,489

(22) Filed: May 30, 2017

(30) Foreign Application Priority Data
May 31, 2016 (JP) 2016-109081
Nov. 17, 2016 (JP) 2016-224435

(51) Int. Cl. G06F 3/01; G06T 7/80; G06F 3/03

(52) U.S. Cl. CPC G06F 3/013; G06F 3/0304; G06T 7/80; G06T 2207/20212

(57) ABSTRACT

A gaze detection system capable of confirming whether or not a user is viewing a marker at the time of calibration is provided. The gaze detection system comprises a head mounted display that is worn and used by a user, and a gaze detection device that detects gaze of the user, wherein the head mounted display includes a display unit that displays an image, an imaging unit that images eyes of the user, and an image output unit that outputs an image including the eyes of the user captured by the imaging unit to the gaze detection device, and the gaze detection device includes a marker image output unit that outputs a marker image to be displayed on the display unit, and a combined image creation unit that creates a combined image obtained by superimposing the marker image output by the marker image output unit and an image including the eyes of the user gazing at the marker image captured by the imaging unit.

### BACKGROUND OF THE INVENTION

### Field of the Invention

The present invention relates to a gaze detection system, and particularly, to a gaze detection technology using a head mounted display.

### Description of Related Art

Conventionally, when gaze detection for specifying a point at which a user is looking is performed, it is necessary to perform calibration. Here, the calibration refers to causing a user to gaze at a specific indicator and specifying a position relationship between a position at which the specific indicator is displayed and a corneal center of the user gazing at the specific indicator. A gaze detection system that performs calibration to perform gaze detection can specify a point at which a user is looking.

Japanese Unexamined Patent Application Publication No. 2012-216123 discloses a technology for performing calibration to perform gaze detection.

### SUMMARY OF THE INVENTION

However, preparation of the calibration is made under the condition that it is determined that a user gazes at a specific indicator. Accordingly, there is a problem in that when information is acquired in a state in which the user does not gaze at the specific indicator, actual gaze detection cannot be accurately executed. The problem is particularly noticeable because an operator cannot confirm from the surroundings whether or not the user is actually gazing at the specific indicator in the case of a head mounted display in which surroundings of the eyes of the user are covered by the device and a state of the inside cannot be viewed.

The present invention has been made in consideration of the above problems, and an object thereof is to provide a technology capable of accurately executing calibration for realizing gaze detection of a user wearing a head mounted display.

In order to solve the above problem, an aspect of the present invention is a gaze detection system including a head mounted display that is worn and used by a user, and a gaze detection device that detects gaze of the user, wherein the head mounted display includes a display unit that displays an image; an imaging unit that images eyes of the user; and an image output unit that outputs an image including the eyes of the user captured by the imaging unit to the gaze detection device, and the gaze detection device includes a marker image output unit that outputs a marker image to be displayed on the display unit; a combined image creation unit that creates a combined image obtained by superimposing the marker image output by the marker image output unit and an image including the eyes of the user gazing at the marker image captured by the imaging unit; and a combined image output unit that outputs the combined image.

Further, the marker image output unit may sequentially change a display position of the marker image and output the marker image, and the imaging unit may image the eyes of the user gazing at the marker image each time at least the display position is changed.

Further, the marker image output unit may change the display position of the marker image to any one of a plurality of predetermined coordinate positions and output the marker image, and the gaze detection device may further include a gaze detection unit that detects a gaze direction of the user on the basis of the image of the eyes of the user captured by the imaging unit and each image including the eyes of the user gazing at the marker image for each display position.

Further, the determination unit may further determine whether or not the user is gazing at the displayed marker image on the basis of the image of the eyes of the user captured by the imaging unit, and the gaze detection system may further include a reporting unit that performs reporting to cause the user to gaze at the marker image when it is determined that the user is not gazing at the marker image.

The marker image output unit may change the display position of the marker image when the determination unit determines that the user is gazing at the displayed marker image.

Further, the gaze detection system may further include: a determination unit that determines whether or not the image including the eyes of the user gazing at the marker image is usable as an image for gaze detection in the gaze detection unit, wherein, when the determination unit determines that the image is not usable as an image for gaze detection, the marker image output unit may change a display position of the marker image displayed when the image corresponding to the determination is captured, to a position close to a center of the display unit and causes the marker image to be displayed, the imaging unit may image the eyes of the user gazing at the marker image of which the display position has been changed, and the determination unit may determine whether or not a comparative image captured again is usable as an image for gaze detection.

Conversion of an arbitrary combination of the above components and the expression of the present invention between a method, a device, a system, a computer program, a data structure, a recording medium, and the like is also effective as an aspect of the present invention.

According to the present invention, it is possible to provide a technology for detecting a gaze direction of a user wearing a head mounted display.

### DETAILED DESCRIPTION OF THE INVENTION

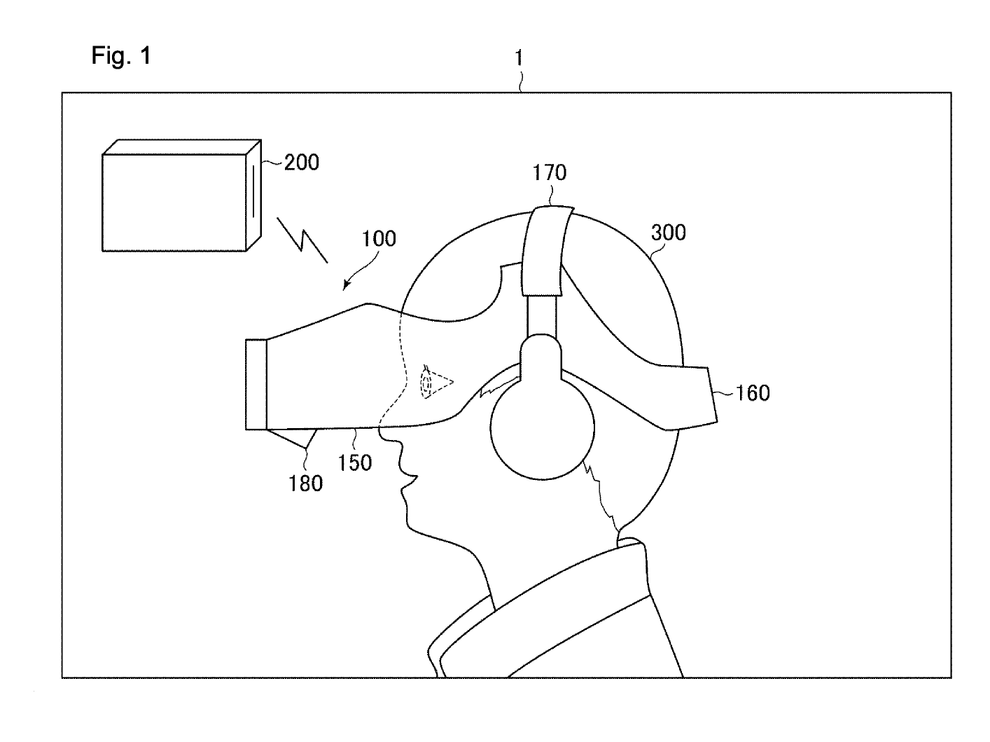

FIG. 1 is an external view illustrating a state in which a user wears a head mounted display according to an embodiment;

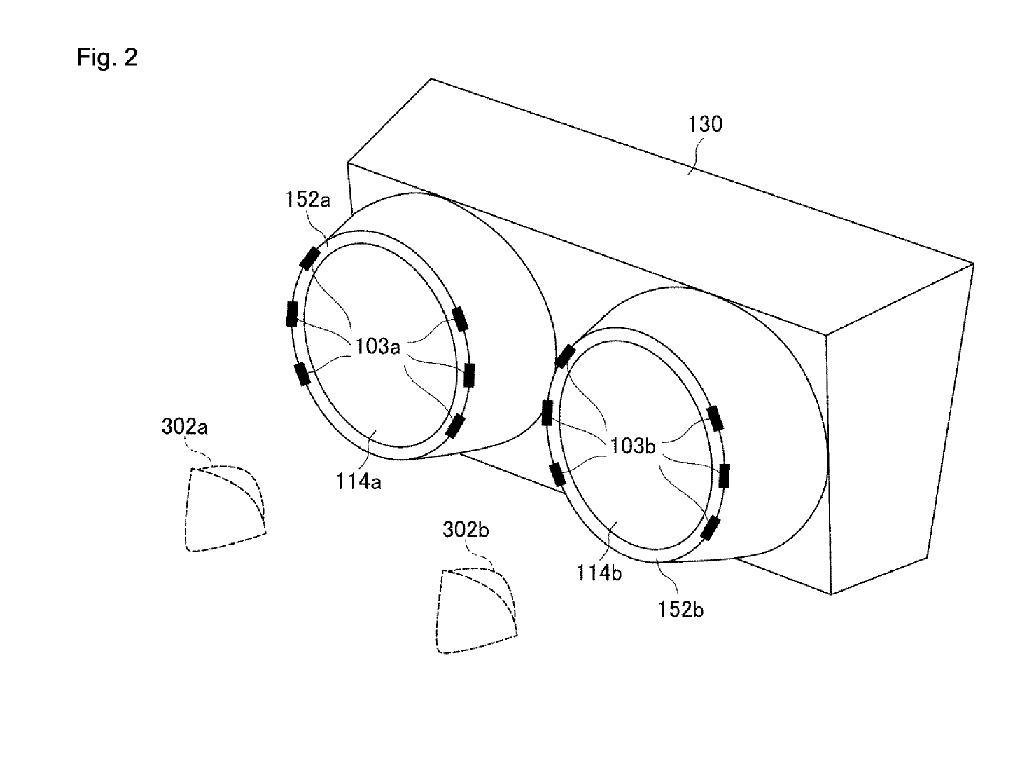

FIG. 2 is a perspective view schematically illustrating an overview of an image display system of the head mounted display according to the embodiment;

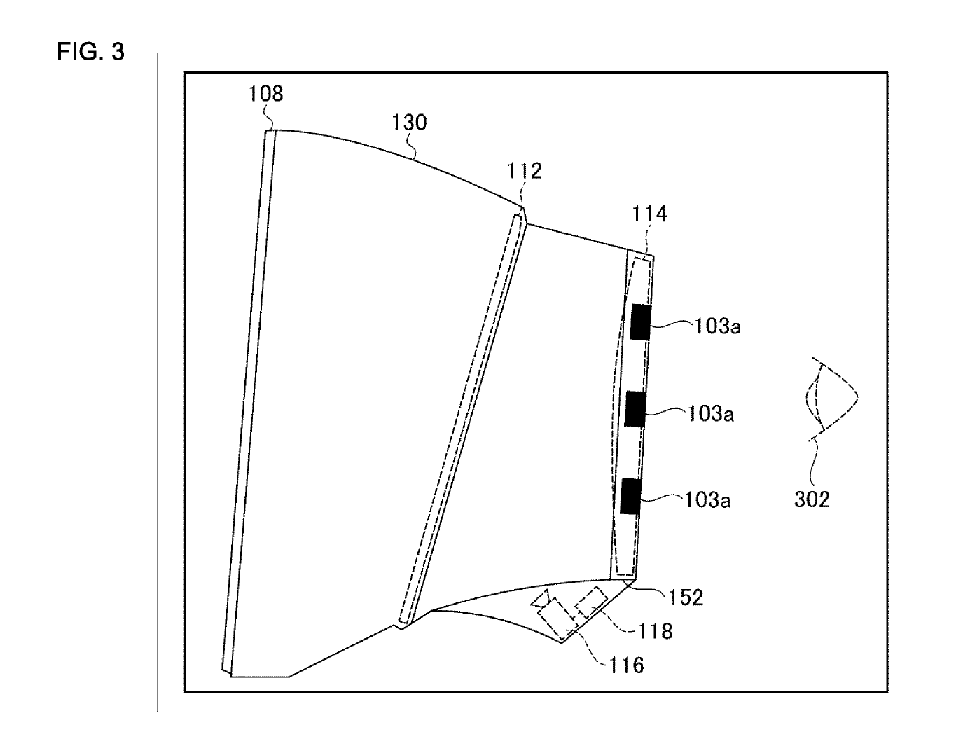

FIG. 3 is a diagram schematically illustrating an optical configuration of an image display system of the head mounted display according to the embodiment;

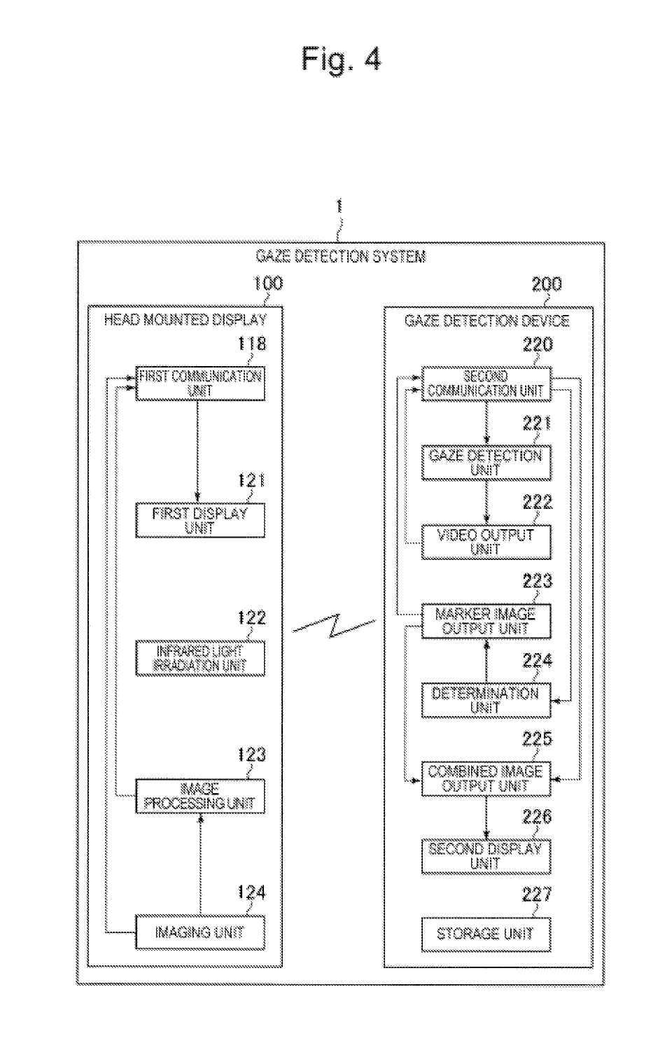

FIG. 4 is a block diagram illustrating a configuration of a gaze detection system according to the embodiment;

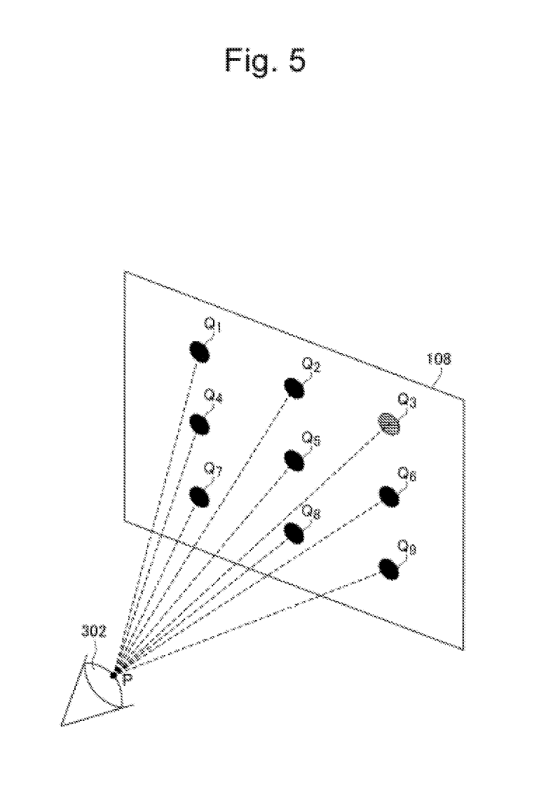

FIG. 5 is a schematic diagram illustrating calibration for detection of a gaze direction according to the embodiment;

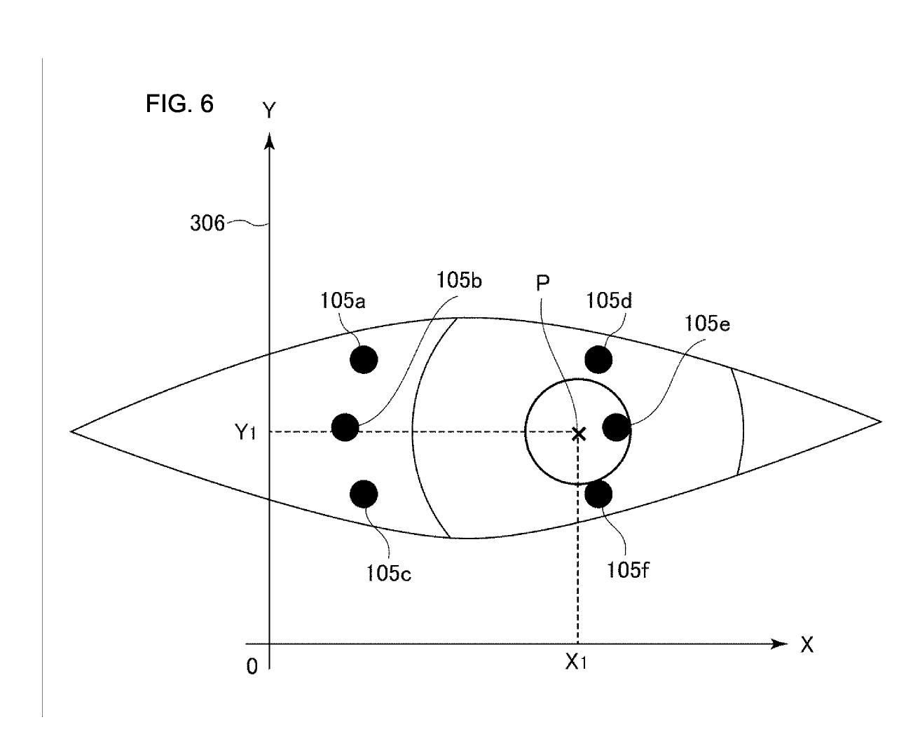

FIG. 6 is a schematic diagram illustrating position coordinates of a cornea of a user;

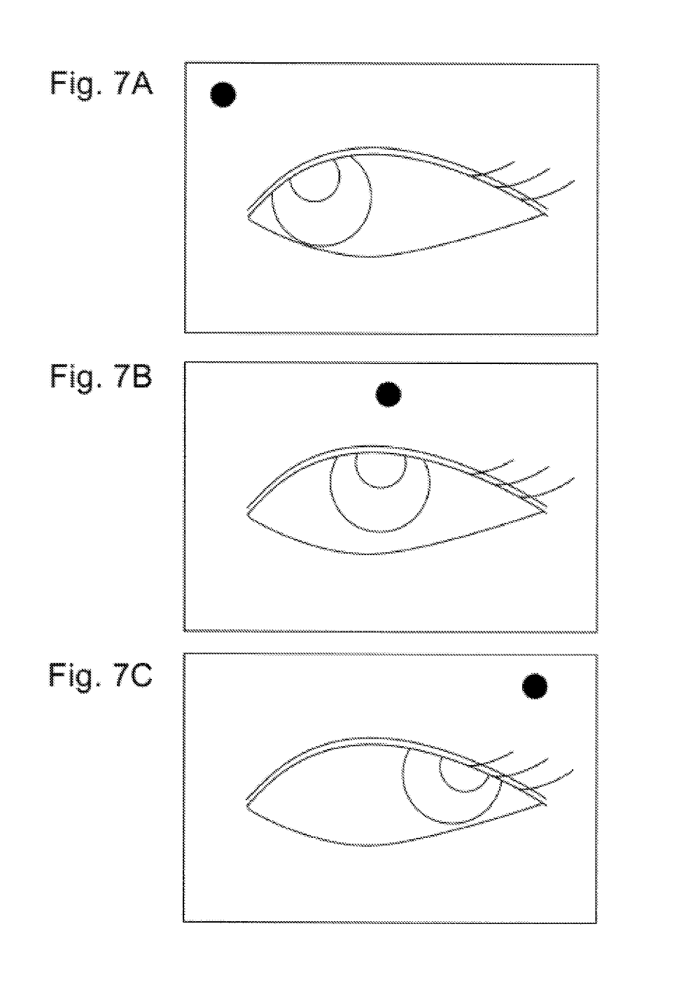

FIGS. 7A to 7C are image diagrams of an eye of a user gazing at a marker image according to the embodiment;

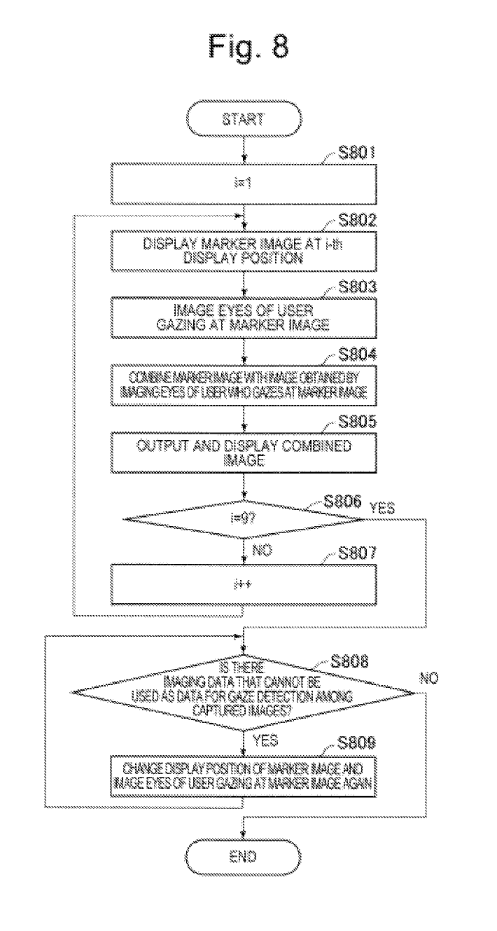

FIG. 8 is a flowchart illustrating an operation of the gaze detection system according to the embodiment;

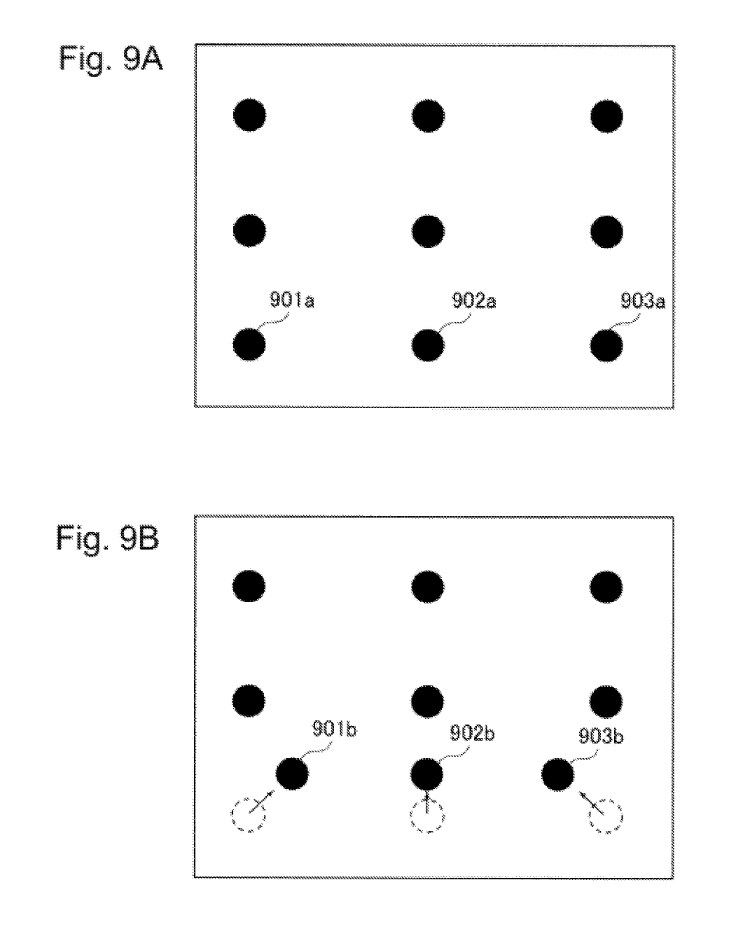

FIG. 9A is an image diagram illustrating an output position of a marker image before correction to a display screen, and FIG. 9B is an image diagram illustrating an example of correction of an output position of the marker image;

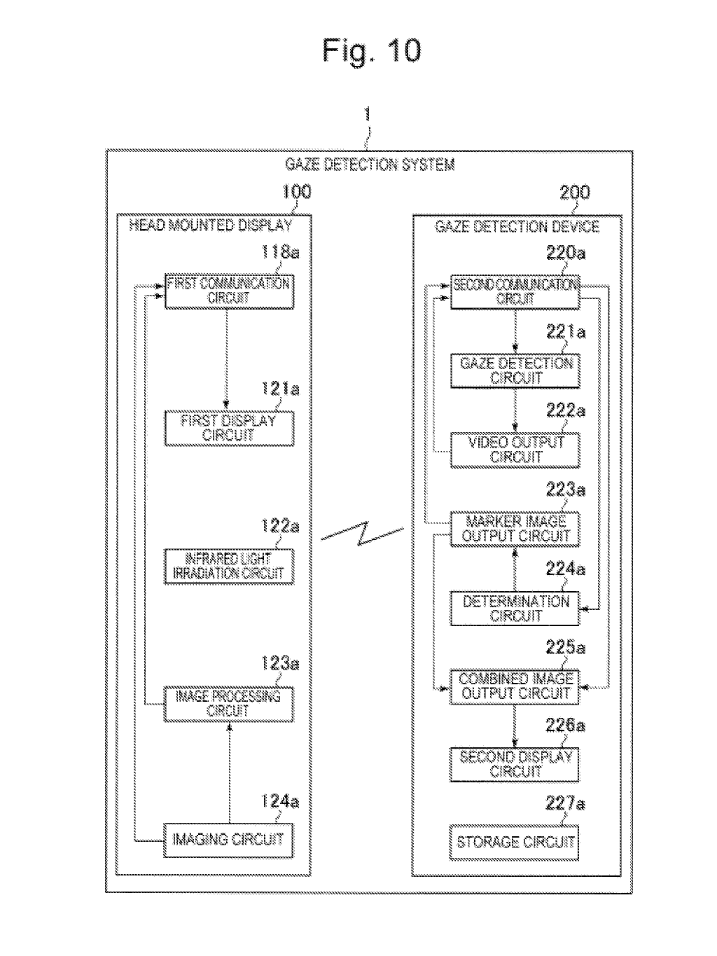

FIG. 10 is a block diagram illustrating a configuration of the gaze detection system;

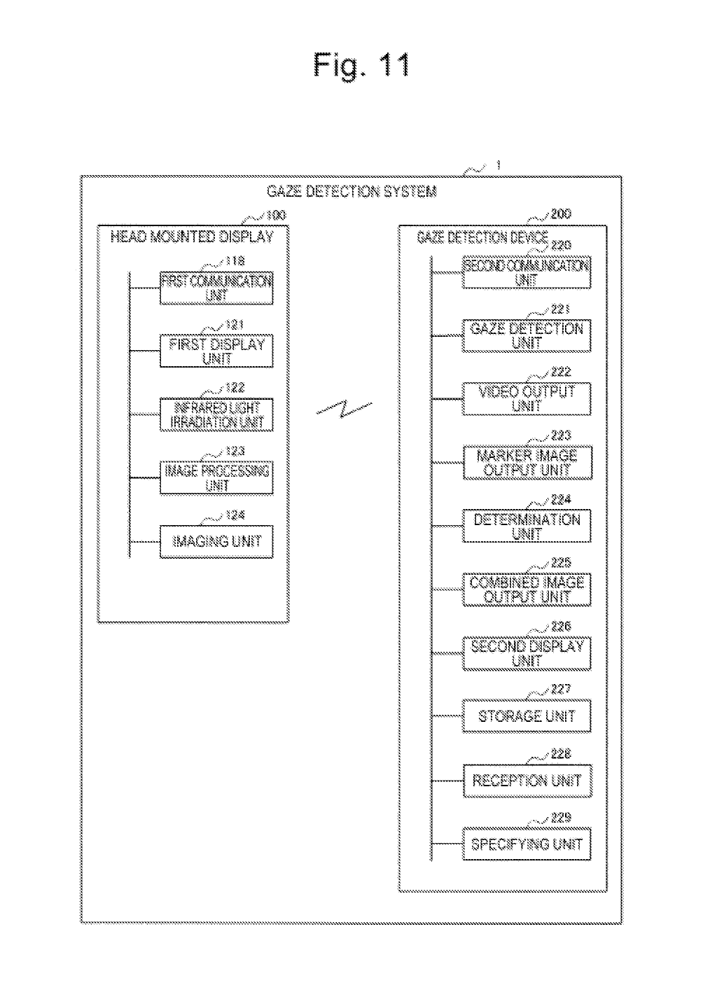

FIG. 11 is a block diagram illustrating a configuration of a gaze detection system according to a second embodiment;

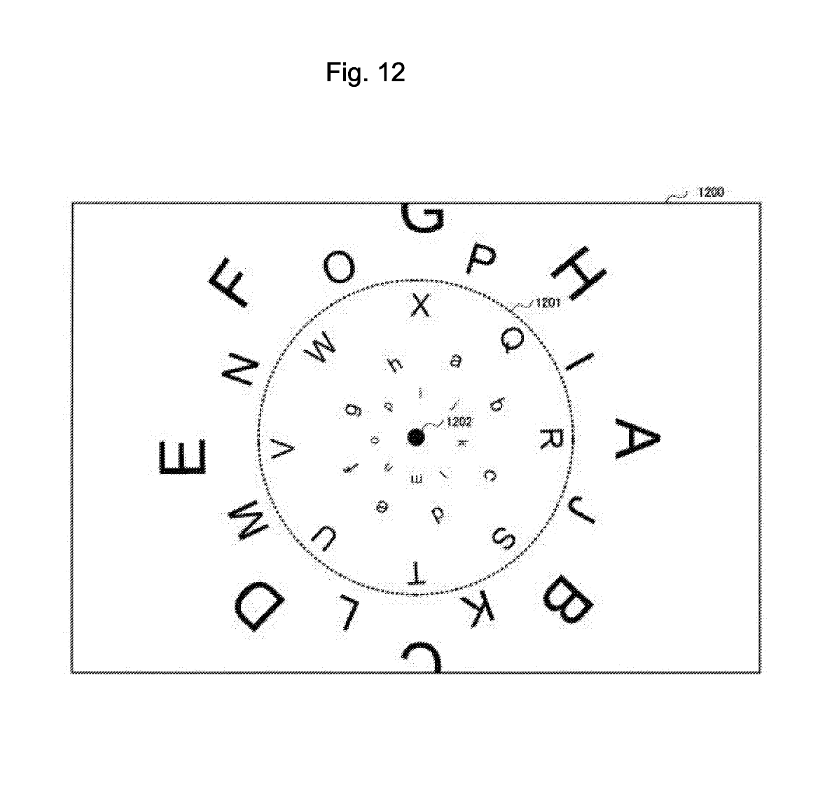

FIG. 12 is a diagram illustrating a display example of an effective field-of-view graph according to the second embodiment;

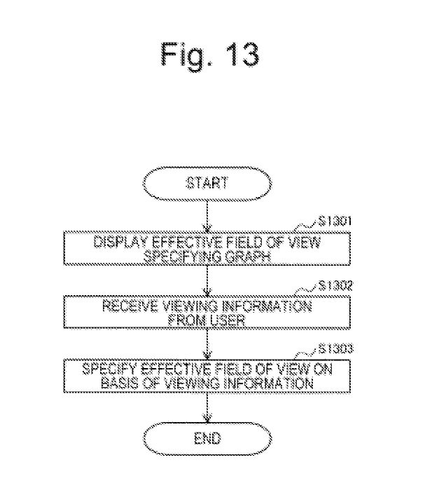

FIG. 13 is a flowchart illustrating an operation of the gaze detection system according to the second embodiment;

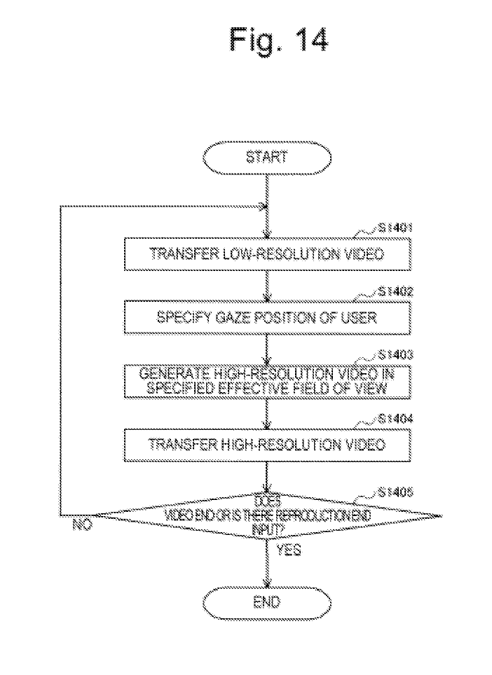

FIG. 14 is a flowchart illustrating an operation of the gaze detection system according to the second embodiment;

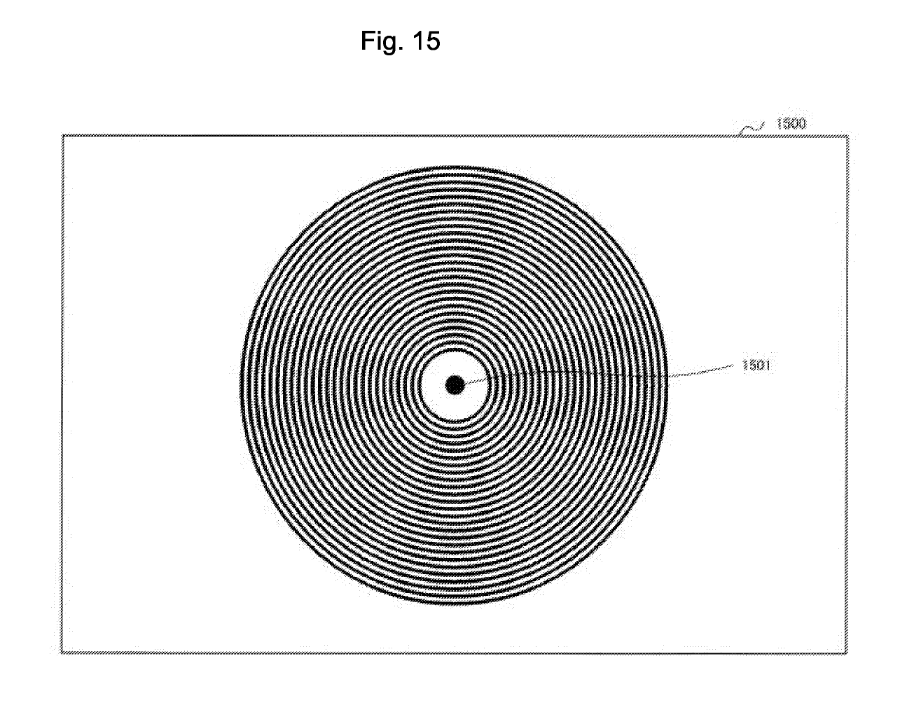

FIG. 15 is a diagram illustrating a display example of an effective field-of-view graph according to a third embodiment;

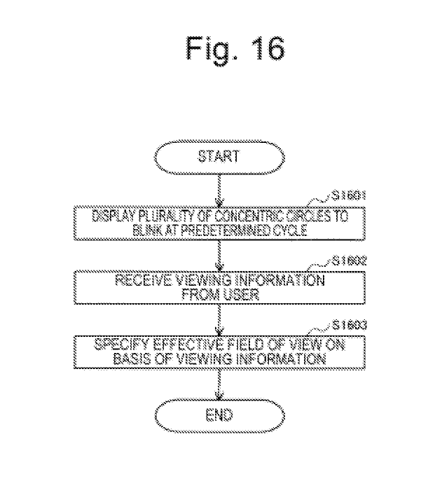

FIG. 16 is a flowchart illustrating an operation of a gaze detection system according to the third embodiment;

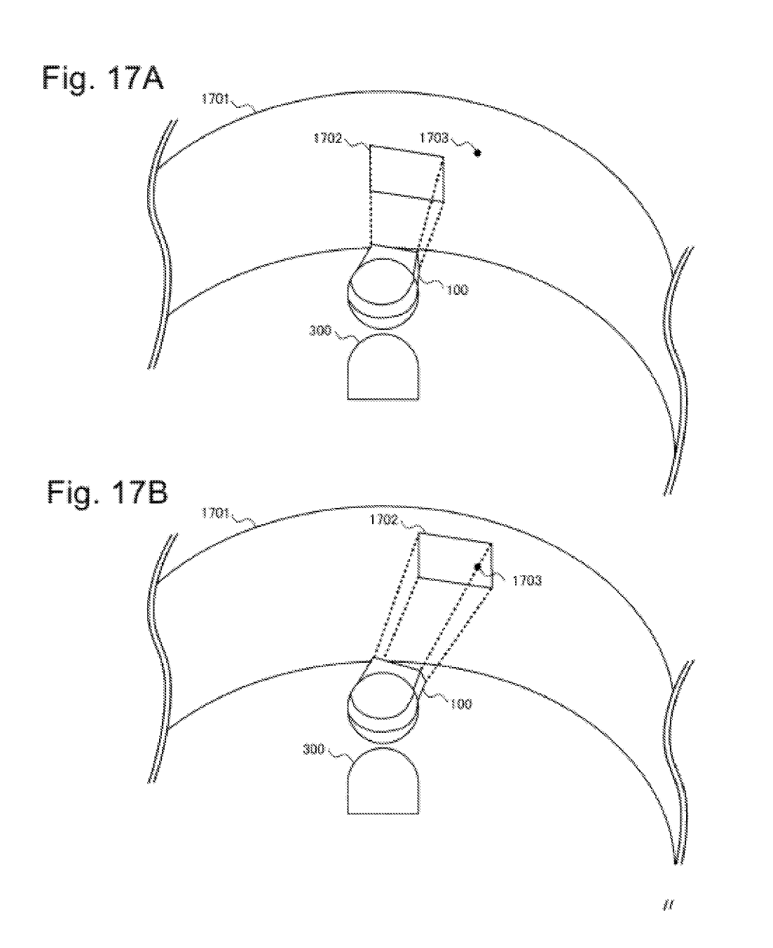

FIGS. 17A and 17B are views schematically illustrating a display example of a marker image according to a fourth embodiment;

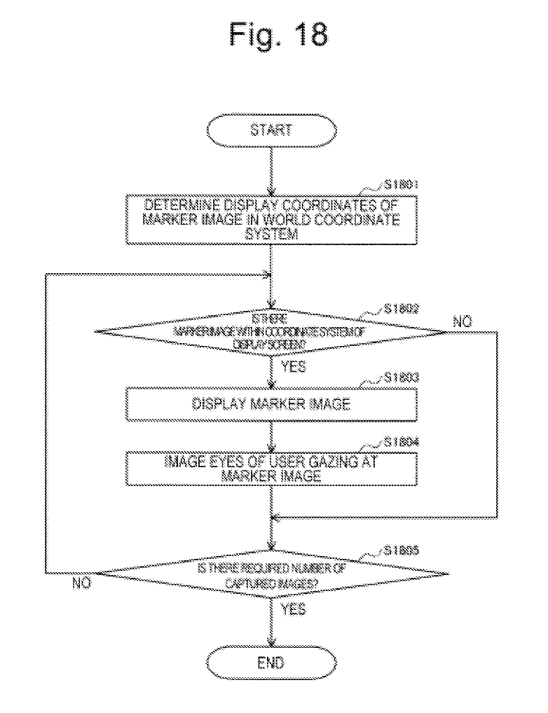

FIG. 18 is a flowchart illustrating an operation of a gaze detection system according to the fourth embodiment;

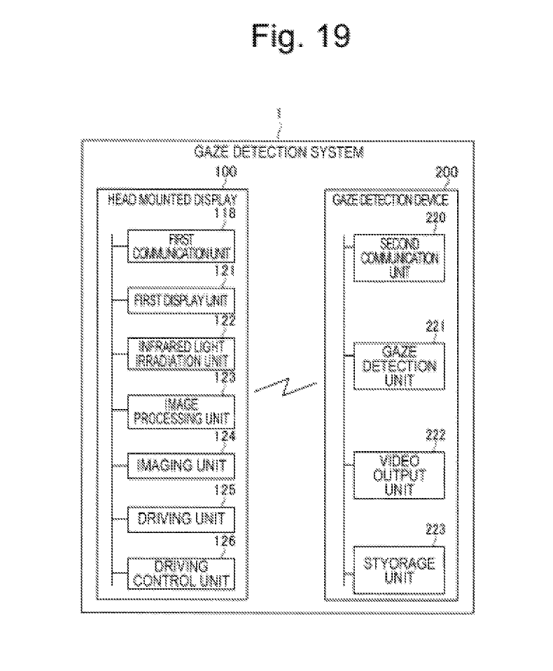

FIG. 19 is a block diagram illustrating a configuration of a gaze detection system according to a fifth embodiment;

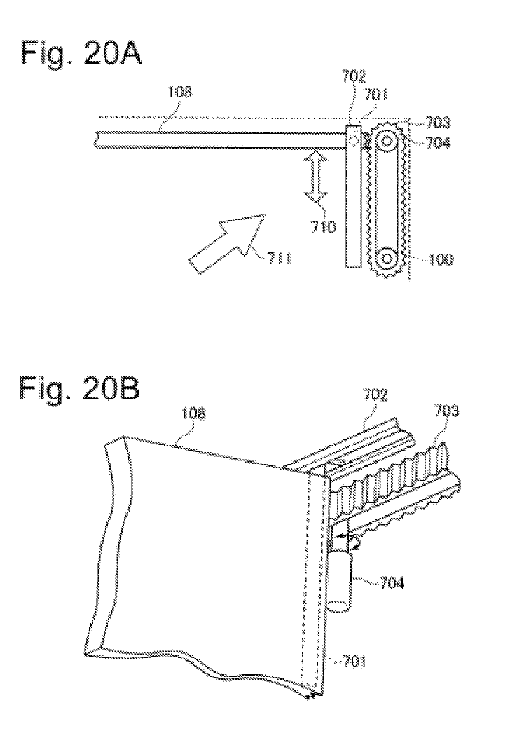

FIGS. 20A and 20B illustrate head mounted displays according to the fifth embodiment, in which FIG. 20A is a plan view of a driving unit, and FIG. 20B is a perspective view of the driving unit;

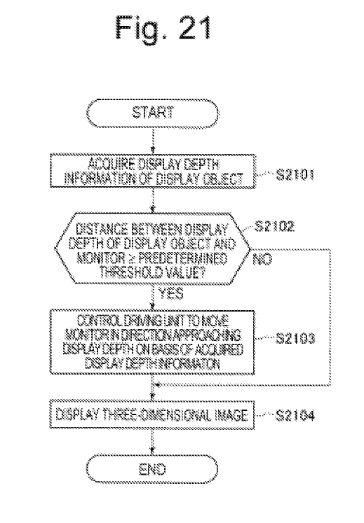

FIG. 21 is a flowchart illustrating an operation of a gaze detection system according to the fifth embodiment; and

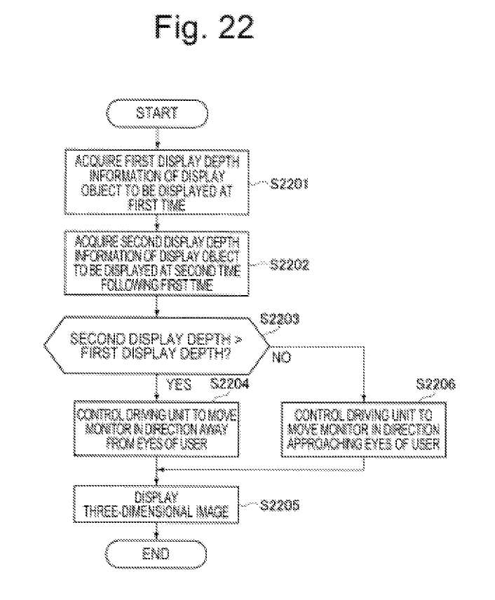

FIG. 22 is a flowchart illustrating an operation of the gaze detection system according to the fifth embodiment.

### DETAILED DESCRIPTION OF THE INVENTION

### First Embodiment

### <Configuration>

FIG. 1 is a diagram schematically illustrating an overview of a gaze detection system 1 according to an embodiment. The gaze detection system 1 according to the embodiment includes a head mounted display 100 and a gaze detection device 200. As illustrated in FIG. 1, the head mounted display 100 is mounted on the head of the user 300 for use.

The gaze detection device 200 detects a gaze direction of right and left eyes of the user wearing the head mounted display 100, and specifies a focal point of the user, that is, a gaze point of the user in a three-dimensional image displayed on the head mounted display. Further, the gaze detection device 200 also functions as a video generation device that generates videos displayed by the head mounted display 100. For example, the gaze detection device 200 is a device capable of reproducing videos of stationary game machines, portable game machines, PCs, tablets, smartphones, phablets, video players, TVs, or the like, but the present invention is not limited thereto. The gaze detection device 200 is wirelessly or wiredly connected to the head mounted display 100. In the example illustrated in FIG. 1, the gaze detection device 200 is wirelessly connected to the head mounted display 100. The wireless connection between the gaze detection device 200 and the head mounted display 100 can be realized using a known wireless communication technique such as Wi-Fi (registered trademark) or Bluetooth (registered trademark). For example, transfer of videos between the head mounted display 100 and the gaze detection device 200 is executed according to a standard such as Miracast (registered trademark), WiGig (registered trademark), or WHDI (registered trademark).

FIG. 1 illustrates an example in which the head mounted display 100 and the gaze detection device 200 are different devices. However, the gaze detection device 200 may be built into the head mounted display 100.

The head mounted display 100 includes a housing 150, a fitting harness 160, and headphones 170. The housing 150 houses an image display system, such as an image display element, for presenting videos to the user 300, and a wireless transfer module (not illustrated) such as a Wi-Fi module or a Bluetooth (registered trademark) module. The fitting harness 160 is used to mount the head mounted display 100 on the head of the user 300. The fitting harness 160 may be realized by, for example, a belt or an elastic band. When the user 300 wears the head mounted display 100 using the fitting harness 160, the housing 150 is arranged at a position where the eyes of the user 300 are covered. Thus, if the user 300 wears the head mounted display 100, a field of view of the user 300 is covered by the housing 150.

The headphones 170 output audio for the video that is reproduced by the gaze detection device 200. The headphones 170 may not be fixed to the head mounted display 100. Even when the user 300 wears the head mounted display 100 using the fitting harness 160, the user 300 may freely attach or detach the headphones 170.

FIG. 2 is a perspective diagram illustrating an overview of the image display system 130 of the head mounted display 100 according to the embodiment. Specifically, FIG. 2 illustrates a region of the housing 150 according to an embodiment that faces corneas 302 of the user 300 when the user 300 wears the head mounted display 100.

As illustrated in FIG. 2, a convex lens 114a for the left eye is arranged at a position facing the cornea 302a of the left eye of the user 300 when the user 300 wears the head mounted display 100. Similarly, a convex lens 114b for a right eye is arranged at a position facing the cornea 302b of the right eye of the user 300 when the user 300 wears the head mounted display 100. The convex lens 114a for the left eye and the convex lens 114b for the right eye are gripped by a lens holder 152a for the left eye and a lens holder 152b for the right eye, respectively.

Hereinafter, in this specification, the convex lens 114a for the left eye and the convex lens 114b for the right eye are simply referred to as a “convex lens 114” unless the two lenses are particularly distinguished. Similarly, the cornea 302a of the left eye of the user 300 and the cornea 302b of the right eye of the user 300 are simply referred to as a “cornea 302” unless the corneas are particularly distinguished. The lens holder 152a for the left eye and the lens holder 152b for the right eye are referred to as a “lens holder 152” unless the holders are particularly distinguished.

A plurality of infrared light sources 103 are included in the lens holders 152. For the purpose of brevity, in FIG. 2, the infrared light sources that irradiate the cornea 302a of the left eye of the user 300 with infrared light are collectively referred to as infrared light sources 103a, and the infrared light sources that irradiate the cornea 302b of the right eye of the user 300 with infrared light are collectively referred to as infrared light sources 103b. Hereinafter, the infrared light sources 103a and the infrared light sources 103b are referred to as “infrared light sources 103” unless the infrared light sources 103a and the infrared light sources 103b are particularly distinguished. In the example illustrated in FIG. 2, six infrared light sources 103a are included in the lens holder 152a for the left eye. Similarly, six infrared light sources 103b are included in the lens holder 152b for the right eye. Thus, the infrared light sources 103 are not directly arranged in the convex lenses 114, but are arranged in the lens holders 152 that grip the convex lenses 114, making the attachment of the infrared light sources 103 easier. This is because machining for attaching the infrared light sources 103 is easier than for the convex lenses 114 that are made of glass or the like since the lens holders 152 are typically made of a resin or the like.

As described above, the lens holders 152 are members that grip the convex lenses 114. Therefore, the infrared light sources 103 included in the lens holders 152 are arranged around the convex lenses 114. Although there are six infrared light sources 103 that irradiate each eye with infrared light herein, the number of the infrared light sources 103 is not limited thereto. There may be at least one light source 103 for each eye, and two or more light sources 103 are desirable.

FIG. 3 is a schematic diagram of an optical configuration of the image display system 130 contained in the housing 150 according to the embodiment, and is a diagram illustrating a case in which the housing 150 illustrated in FIG. 2 is viewed from a side surface on the left eye side. The image display system 130 includes infrared light sources 103, an image display element 108, a hot mirror 112, the convex lenses 114, a camera 116, and a first communication unit 118.

The infrared light sources 103 are light sources capable of emitting light in a near-infrared wavelength region (700 nm to 2500 nm range). Near-infrared light is generally light in a wavelength region of non-visible light that cannot be observed by the naked eye of the user 300.

The image display element 108 displays an image to be presented to the user 300. The image to be displayed by the image display element 108 is generated by a video output unit 222 in the gaze detection device 200. The video output unit 222 will be described below. The image display element 108 can be realized by using an existing liquid crystal display (LCD) or organic electro luminescence display (organic EL display).

The hot mirror 112 is arranged between the image display element 108 and the cornea 302 of the user 300 when the user 300 wears the head mounted display 100. The hot mirror 112 has a property of transmitting visible light created by the image display element 108, but reflecting near-infrared light.

The convex lenses 114 are arranged on the opposite side of the image display element 108 with respect to the hot mirror 112. In other words, the convex lenses 114 are arranged between the hot mirror 112 and the cornea 302 of the user 300 when the user 300 wears the head mounted display 100. That is, the convex lenses 114 are arranged at positions facing the corneas 302 of the user 300 when the user 300 wears the head mounted display 100.

The convex lenses 114 condense image display light that is transmitted through the hot mirror 112. Thus, the convex lenses 114 function as image magnifiers that enlarge an image created by the image display element 108 and present the image to the user 300. Although only one of each convex lens 114 is illustrated in FIG. 2 for convenience of description, the convex lenses 114 may be lens groups configured by combining various lenses or may be a plano-convex lens in which one surface has curvature and the other surface is flat.

A plurality of infrared light sources 103 are arranged around the convex lens 114. The infrared light sources 103 emit infrared light toward the cornea 302 of the user 300.

Although not illustrated in the figure, the image display system 130 of the head mounted display 100 according to the embodiment includes two image display elements 108, and can independently generate an image to be presented to the right eye of the user 300 and an image to be presented to the left eye of the user. Accordingly, the head mounted display 100 according to the embodiment may present a parallax image for the right eye and a parallax image for the left eye to the right and left eyes of the user 300. Thereby, the head mounted display 100 according to the embodiment can present a stereoscopic video that has a feeling of depth for the user 300.

As described above, the hot mirror 112 transmits visible light but reflects near-infrared light. Thus, the image light emitted by the image display element 108 is transmitted through the hot mirror 112, and reaches the cornea 302 of the user 300. The infrared light emitted from the infrared light sources 103 and reflected in a reflective area inside the convex lens 114 reaches the cornea 302 of the user 300.

The infrared light reaching the cornea 302 of the user 300 is reflected by the cornea 302 of the user 300 and is directed to the convex lens 114 again. This infrared light is transmitted through the convex lens 114 and is reflected by the hot mirror 112. The camera 116 includes a filter that blocks visible light and images the near-infrared light reflected by the hot mirror 112. That is, the camera 116 is a near-infrared camera which images the near-infrared light emitted from the infrared light sources 103 and reflected by the cornea of the eye of the user 300.

Although not illustrated in the figure, the image display system 130 of the head mounted display 100 according to the embodiment includes two cameras 116, that is, a first imaging unit that captures an image including the infrared light reflected by the right eye and a second imaging unit that captures an image including the infrared light reflected by the left eye. Thereby, images for detecting gaze directions of both the right eye and the left eye of the user 300 can be acquired.

The first communication unit 118 outputs the image captured by the camera 116 to the gaze detection device 200 that detects the gaze direction of the user 300. Specifically, the first communication unit 118 transmits the image captured by the camera 116 to the gaze detection device 200. Although the gaze detection unit 221 functioning as a gaze direction detection unit will be described below in detail, the gaze direction unit is realized by a gaze detection program executed by a central processing unit (CPU) of the gaze detection device 200. When the head mounted display 100 includes computational resources such as a CPU or a memory, the CPU of the head mounted display 100 may execute the program that realizes the gaze direction detection unit.

As will be described below in detail, bright spots caused by near-infrared light reflected by the cornea 302 of the user 300 and an image of the eyes including the cornea 302 of the user 300 observed in a near-infrared wavelength region are captured in the image captured by the camera 116.

Although the configuration for presenting the image to the left eye of the user 300 in the image display system 130 according to the embodiment has mainly been described above, a configuration for presenting an image to the right eye of the user 300 is the same as above.

FIG. 4 is a block diagram of the head mounted display 100 and the gaze detection device 200 according to the gaze detection system 1. As illustrated in FIG. 4, and as described above, the gaze detection system 1 includes the head mounted display 100 and the gaze detection device 200 which communicate with each other.

As illustrated in FIG. 4, the head mounted display 100 includes the first communication unit 118, the display unit 121, the infrared light irradiation unit 122, the image processing unit 123, and the imaging unit 124.

The first communication unit 118 is a communication interface having a function of communicating with the second communication unit 220 of the gaze detection device 200. As described above, the first communication unit 118 communicates with the second communication unit 220 through wired or wireless communication. Examples of usable communication standards are as described above. The first communication unit 118 transmits image data to be used for gaze detection transferred from the imaging unit 124 or the image processing unit 123 to the second communication unit 220. Further, the first communication unit 118 transfers three-dimensional image data or the marker image transmitted from the gaze detection device 200 to the display unit 121.

The display unit 121 has a function of displaying the three-dimensional image transferred from the first communication unit 118 on the image display element 108. The three-dimensional image data includes a parallax image for the right eye and a parallax image for the left eye, which form a parallax image pair. The first display unit 121 displays the marker image output from the marker image output unit 223 at the designated coordinates of the image display element 108.

The infrared light irradiation unit 122 controls the infrared light sources 103 and irradiates the right eye or the left eye of the user with infrared light.

The image processing unit 123 performs image processing on the image captured by the imaging unit 124 as necessary, and transfers a processed image to the first communication unit 118.

The imaging unit 124 captures an image of near-infrared light reflected by each eye using the camera 116. The imaging unit 124 captures an image including the eyes of the user gazing at the marker image displayed on the image display element 108. The imaging unit 124 transfers the image obtained by the imaging to the first communication unit 118 or the image processing unit 123. The imaging unit 124 may capture a moving image or may capture a still image at an appropriate timing (for example, a timing at which near-infrared light is emitted or a timing at which the marker image is displayed).

As illustrated in FIG. 4, the gaze detection device 200 includes the second communication unit 220, the gaze detection unit 221, the video output unit 222, the marker image output unit 223, a determination unit 224, a combined image output unit 225, a second display unit 226, and the storage unit 227.

The second communication unit 220 is a communication interface having a function of communicating with the first communication unit 118 of the head mounted display 100. As described above, the second communication unit 220 communicates with the first communication unit 118 through wired communication or wireless communication. The second communication unit 220 transmits the three-dimensional image data transferred from the video output unit 222, and the marker image and the display coordinate position thereof transferred from the marker image output unit 223 to the head mounted display 100. Further, the image including the eyes of the user gazing at the marker image captured by the imaging unit 124, transferred from the head mounted display 100, is transferred to the determination unit 224 and the combined image output unit 225, and an image obtained by imaging the eyes of the user viewing the image displayed on the basis of the three-dimensional image data output by the video output unit 222 is transferred to the gaze detection unit 221.

The gaze detection unit 221 receives the image data for gaze detection of the right eye of the user from the second communication unit 220, and detects the gaze direction of the right eye of the user. Using a scheme to be described below, the gaze detection unit 221 calculates a right eye gaze vector indicating a gaze direction of the right eye of the user, calculates a left eye gaze vector indicating a gaze direction of the left eye of the user, and specifies a point at which the user is gazing in the image displayed on the image display element 108.

The video output unit 222 generates the three-dimensional video data to be displayed by the first display unit 121 of the head mounted display 100 and transfers the three-dimensional video data to the second communication unit 220. The video output unit 222 holds the coordinate system of the three-dimensional image to be output, and information indicating the three-dimensional position coordinates of the object to be displayed in the coordinate system.

The marker image output unit 223 has a function of generating a marker image serving as an index for performing calibration which is preparation for gaze detection, and determining a display position thereof. The marker image output unit 223 generates the marker image and determines a display coordinate position at which the marker image is to be displayed on the image display element 108. The marker image output unit 223 transfers the generated marker image and the display coordinate position to the second communication unit 220 and instructs the second communication unit 220 to transmit the generated marker image and a display coordinate position thereof to the head mounted display 100. In this embodiment, the marker image output unit 223 changes the display position of the marker image according to an input instruction from the operator of the gaze detection device 200.

Further, when the fact that the image including the eyes of the user cannot be used as the gaze detection image and the display coordinate position of the marker image at that time are transferred from the determination unit 224, the marker image output unit 223 transfers a new display coordinate position obtained by changing the display coordinate position to a coordinate position closer to the center of the image display element 108 and the marker image to the second communication unit 220, and instructs the second communication unit 220 to transmit the new display coordinate position and the marker image to the head mounted display 100.

The determination unit 224 has a function of determining whether or not the image of the eyes of the user in the image can be used as an image for gaze detection on the basis of the image including the eyes of the user gazing at the marker image transferred from the second communication unit 220. Specifically, the determination unit 224 specifies an iris (cornea) of the user in the image including the eyes of the user gazing at the marker image transferred from the second communication unit 220, and performs the determination according to whether a center position thereof can be specified. When the determination unit 224 determines that the image including the eyes of the user gazing at the marker image transferred from the second communication unit 220 cannot be used as an image for gaze detection, that is, the center of the iris cannot be specified, the determination unit 224 notifies the marker image output unit 223 of that fact together with the display coordinate position of the marker image.

The combined image output unit 225 has a function of combining an image obtained by inverting left and right sides of the display position of the marker image output from the marker image output unit 223 with the captured image including the eyes of the user gazing at the marker image transferred from the second communication unit 220, and outputting a combined image. The combined image output unit 225 outputs the generated combined image to the second display unit 226.

The second display unit 226 includes a monitor that displays an image and has a function of displaying a combined image transferred from the combined image output unit 225. That is, the second display unit 226 displays a combined image obtained by superimposing the image of the eyes of the user gazing at the marker image and the marker image displayed at the corresponding position at that time.

The storage unit 227 is a recording medium that stores various programs or data required for the operation of the gaze detection device 200. In FIG. 4, although connection lines to other functional units are not illustrated for the storage unit 227, each functional unit appropriately accesses the storage unit 227 and refers to a necessary program or data. Next, the gaze direction detection according to the embodiment will be described.

FIG. 5 is a schematic diagram illustrating calibration for detection of the gaze direction according to the embodiment. The gaze direction of the user 300 is realized by the gaze detection unit 221 in the gaze detection device 200 analyzing the video captured by the camera 116 and output to the gaze detection device 200 by the first communication unit 118.

The marker image output unit 223 generates nine points (marker images) including points Q₁ to Q₉ as illustrated in FIG. 5, and causes the points to be displayed by the image display element 108 of the head mounted display 100. The gaze detection device 200 causes the user 300 to sequentially gaze at the points Q₁ up to Q₉. In this case, the user 300 is requested to gaze at each of the points by moving his or her eyeballs as much as possible without moving his or her neck. The camera 116 captures images including the cornea 302 of the user 300 when the user 300 is gazing at the nine points including the points Q₁ to Q₉.

FIG. 6 is a schematic diagram illustrating the position coordinates of the cornea 302 of the user 300. The gaze detection unit 221 in the gaze detection device 200 analyzes the images captured by the camera 116 and detects bright spots 105 derived from the infrared light. When the user 300 gazes at each point by moving only his or her eyeballs, the positions of the bright spots 105 are considered to be stationary regardless of the point at which the user gazes. Thus, on the basis of the detected bright spots 105, the gaze detection unit 221 sets a two-dimensional coordinate system 306 in the image captured by the camera 116.

Further, the gaze detection unit 221 detects the center P of the cornea 302 of the user 300 by analyzing the image captured by the camera 116. This is realized by using known image processing such as the Hough transform or an edge extraction process. Accordingly, the gaze detection unit 221 can acquire the coordinates of the center P of the cornea 302 of the user 300 in the set two-dimensional coordinate system 306.

In FIG. 5, the coordinates of the points Q₁ to Q₉ in the two-dimensional coordinate system set for the display screen displayed by the image display element 108 are Q₁(x1, y1)^{T}, Q₂(x2, y2)^{T}, . . . , Q₉(x9, y9)^{T}, respectively. The coordinates are, for example, a number of a pixel located at a center of each point. Further, the center points P of the cornea 302 of the user 300 when the user 300 gazes at the points Q1 to Q9 are labeled P₁ to P₉. In this case, the coordinates of the points P1 to P9 in the two-dimensional coordinate system 306 are P₁(X1, Y1)^{T}, P₂(X2, Y2)^{T}, . . . , P₉(X9, Y9)^{T}. T represents a transposition of a vector or a matrix.

A matrix M with a size of 2×2 is defined as Equation (1) below.

$$M = ( \begin{matrix}{m}_{11} & {m}_{12} \\ {m}_{21} & {m}_{22}\end{matrix} ) \qquad ( 1 )$$

In this case, if the matrix M satisfies Equation (2) below, the matrix M is a matrix for projecting the gaze direction of the user 300 onto an image plane that is displayed by the image display element 108.

Q_{N}=MP_{N}(N=1, . . . ,9) (2)

When Equation (2) is written specifically, Equation (3) below is obtained.

$$( \begin{matrix}{x}_{1} & {x}_{2} & … & {x}_{9} \\ {y}_{1} & {y}_{2} & … & {y}_{9}\end{matrix} ) = ( \begin{matrix}{m}_{11} & {m}_{12} \\ {m}_{21} & {m}_{22}\end{matrix} ) ( \begin{matrix}{X}_{1} & {X}_{2} & … & {X}_{9} \\ {Y}_{1} & {Y}_{2} & … & {Y}_{9}\end{matrix} ) \qquad ( 3 )$$

By transforming Equation (3), Equation (4) below is obtained.

$$( \begin{matrix}{x}_{1} \\ {x}_{2} \\ ⋮ \\ {x}_{9} \\ {y}_{1} \\ {y}_{2} \\ ⋮ \\ {y}_{9}\end{matrix} ) = ( \begin{matrix}{X}_{1} & {Y}_{1} & 0 & 0 \\ {X}_{2} & {Y}_{2} & 0 & 0 \\ ⋮ & ⋮ & ⋮ & ⋮ \\ {X}_{9} & {Y}_{9} & 0 & 0 \\ 0 & 0 & {X}_{1} & {Y}_{1} \\ 0 & 0 & {X}_{2} & {Y}_{2} \\ ⋮ & ⋮ & ⋮ & ⋮ \\ 0 & 0 & {X}_{9} & {Y}_{9}\end{matrix} ) ( \begin{matrix}{m}_{11} \\ {m}_{12} \\ {m}_{21} \\ {m}_{22}\end{matrix} ) \\ if \\ y = ( \begin{matrix}{x}_{1} \\ {x}_{2} \\ ⋮ \\ {x}_{9} \\ {y}_{1} \\ {y}_{2} \\ ⋮ \\ {y}_{9}\end{matrix} ) , A = ( \begin{matrix}{X}_{1} & {Y}_{1} & 0 & 0 \\ {X}_{2} & {Y}_{2} & 0 & 0 \\ ⋮ & ⋮ & ⋮ & ⋮ \\ {X}_{9} & {Y}_{9} & 0 & 0 \\ 0 & 0 & {X}_{1} & {Y}_{1} \\ 0 & 0 & {X}_{2} & {Y}_{2} \\ ⋮ & ⋮ & ⋮ & ⋮ \\ 0 & 0 & {X}_{9} & {Y}_{9}\end{matrix} ) , x = ( \begin{matrix}{m}_{11} \\ {m}_{12} \\ {m}_{21} \\ {m}_{22}\end{matrix} ) , \qquad ( 4 )$$

Equation (5) below is obtained:

y=Ax (5)

In Equation (5), elements of the vector y are known since these are coordinates of the points Q₁ to Q₉ that are displayed on the image display element 108 by the gaze detection unit 221. Further, the elements of the matrix A can be acquired since the elements are coordinates of a vertex P of the cornea 302 of the user 300. Thus, the gaze detection unit 221 can acquire the vector y and the matrix A. A vector x that is a vector in which elements of a transformation matrix M are arranged is unknown. Since the vector y and matrix A are known, an issue of estimating matrix M becomes an issue of obtaining the unknown vector x.

Equation (5) becomes the main issue to decide if the number of equations (that is, the number of points Q presented to the user 300 by the gaze detection unit 221 at the time of calibration) is larger than the number of unknown numbers (that is, the number 4 of elements of the vector x). Since the number of equations is nine in the example illustrated in Equation (5), Equation (5) is the main issue to decide.

An error vector between the vector y and the vector Ax is defined as vector e. That is, e=y−Ax. In this case, a vector xₒₚₜ that is optimal in the sense of minimizing the sum of squares of the elements of the vector e can be obtained from Equation (6) below.

xₒₚₜ=(A^{T}A)⁻¹AT_{y} (6)

Here, “−1” indicates an inverse matrix.

The gaze detection unit 221 uses the elements of the obtained vector xₒₚₜ to constitute the matrix M of Equation (1). Accordingly, using the coordinates of the vertex P of the cornea 302 of the user 300 and the matrix M, the gaze detection unit 221 estimates a point at which the right eye of the user 300 is gazing on the video displayed by the image display element 108 within a two-dimensional range using Equation (2). Accordingly, the gaze detection unit 221 can calculate a right gaze vector that connects a gaze point of the right eye on the image display element 108 to a vertex of the cornea of the right eye of the user. Similarly, the gaze detection unit 221 can calculate a left gaze vector that connects a gaze point of the left eye on the image display element 108 to a vertex of the cornea of the left eye of the user.

FIGS. 7A to 7C are diagrams illustrating an example of a combined image that is output by the combined image output unit 225. FIG. 7A is a diagram illustrating an example of a combined image obtained by combining an image obtained by imaging the left eye of the user gazing at the marker image with the marker image displayed at a relative position with respect to the screen at that time when the marker image is displayed at an upper right position when viewed by the user in the head mounted display 100, that is, at a position of the point Q₃ in FIG. 5. In a state in which the eyes of the user are viewed, the position of the marker image is left-right symmetrical.

FIG. 7B is a diagram illustrating an example of a combined image obtained by combining an image obtained by imaging the left eye of the user gazing at the marker image with the marker image displayed at a relative position with respect to the screen at that time when the marker image is displayed at an upper center of the screen when viewed by the user in the head mounted display 100, that is, at a position of the point Q₂ in FIG. 5. In a state in which the eyes of the user are viewed, the position of the marker image is left-right symmetrical.

FIG. 7C is a diagram illustrating an example of a combined image obtained by combining an image obtained by imaging the left eye of the user gazing at the marker image with the marker image displayed at a relative position with respect to the screen at that time when the marker image is displayed at an upper left position when viewed by the user in the head mounted display 100, that is, at a position of the point Q₁ in FIG. 5.

By displaying such a combined image on the second display unit 226, the operator of the gaze detection system 1 can recognize whether or not the user wearing the head mounted display 100 is gazing at the marker image at the time of calibration. Although not illustrated in FIGS. 7A to 7C, such a combined image is generated and displayed for each of the nine points Q₁ to Q₉ illustrated in FIG. 5. Further, although FIGS. 7A to 7C illustrate an example of the left eye of the user, the same combined image can be obtained for the right eye of the user.

### <Operation>

FIG. 8 is a flowchart illustrating an operation at the time of calibration of the gaze detection system 1. The operation of the gaze detection system 1 will be described with reference to FIG. 8.

The marker image output unit 223 of the gaze detection device 200 sets i=1 for the marker image Qᵢ to be displayed (step S801).

The marker image output unit 223 causes the marker image to be displayed at the i-th display coordinate position on the image display element 108 of the head mounted display 100 (step S802). That is, the marker image output unit 223 generates the marker image and determines the display coordinate position. For example, when i=1, the marker image output unit 223 determines the point Q₁ as the display coordinate position. The marker image output unit 223 transfers the generated marker image and the display coordinate position to the second communication unit 220. The second communication unit 220 transmits the transferred marker image and the transferred display coordinate position to the head mounted display 100.

When the first communication unit 118 of the head mounted display 100 receives the marker image and the display coordinate position, the first communication unit 118 transfers the marker image and the display coordinate position to the first display unit 121. The first display unit 121 displays the transferred marker image at the designated display coordinate position on the image display element 108. The user gazes at the displayed marker image. The imaging unit 124 captures an image including the eyes of the user gazing at the displayed marker image (step S803). The imaging unit 124 transfers the captured image to the first communication unit 118. The first communication unit 118 transmits image data of an image obtained by imaging the eyes of the user who gazes at the transferred marker image to the gaze detection device 200.

When the second communication unit 220 of the gaze detection device 200 receives the image data of the image obtained by imaging the eyes of the user gazing at the marker image, the second communication unit 220 transfers the image data to the combined image output unit 225. The combined image output unit 225 superimposes and combines the marker image displayed at that time on the image obtained by imaging the eyes of the user who gazes at the transferred marker image at positions obtained by reversing the right and the left of the display position, to generate a combined image (step S804).

The combined image output unit 225 transfers the generated combined image to the second display unit 226, and the second display unit 226 displays the transferred combined image (step S805). Accordingly, an operator of the gaze detection system 1 can confirm whether or not the user wearing the head mounted display 100 is gazing at the marker image and can instruct the user to gaze at the marker image when the user is not gazing at the marker image.

The marker image output unit 223 determines whether or not i is equal to 9. If i is not 9, the marker image output unit 223 adds 1 to i, and proceeds to step S802. If i is 9, the determination unit 224 determines whether or not each of the nine images obtained by imaging is usable as data for gaze detection (step S807). That is, the determination unit 224 determines whether or not a corneal center of the user can be specified for each of the images obtained by imaging the eyes of the user who gazes at the marker image displayed at each display coordinate position. When the corneal center of the user can be specified, the coordinate position is stored in the storage unit 227 and used in the above matrix formula. When the corneal center of the user cannot be specified, the determination unit 224 transfers the display coordinate position of the marker image displayed when the corneal center of the user cannot be specified, and the fact that the corneal center of the user cannot be specified from the image of the eyes of the user gazing at the marker image, to the marker image output unit 223.

The marker image output unit 223 corrects the display coordinate position of the marker image when the image in which the corneal center of the user cannot be specified has been captured, to a position close to a center of the screen (the image display element 108). The display coordinate position after correction is transferred to the second communication unit 220. The second communication unit 220 transmits the transferred display coordinate position to the head mounted display 100. The first communication unit 118 transfers the received display coordinate position after correction to the first display unit 121. The first display unit 121 displays the marker image at the transferred display coordinate position after the correction so that the user can gaze at the marker image. The imaging unit 124 images the eyes of the user gazing at the marker image displayed at the display coordinate position after the correction (step S809). The imaging unit 124 transfers the captured image to the first communication unit 118, and the first communication unit 118 transmits the captured image to the gaze detection device 200. Then, the process returns to step 808.

On the other hand, when the determination unit 224 determines that all of the captured images can be used as the data for gaze detection, that is, when the corneal center of the user can be specified from all of the images, elements of the matrix x are calculated and the calibration process ends.

The operation at the time of calibration of the gaze detection system 1 has been described above.

FIGS. 9A to 9B are image diagrams illustrating an example of a change in the display coordinate positions of the marker images in the marker image output unit 223. FIG. 9A is a diagram illustrating basic positions of the display positions of the marker images in the image display element 108. In FIG. 9A, a total of nine marker images are illustrated, but in practice, the marker images are displayed sequentially one by one in the image display element 108. That is, nine images obtained by imaging the eyes of the user are obtained.

In this case, for example, when the respective marker images 901a, 902a, and 903a among the marker images illustrated in FIG. 9A are displayed at the coordinate display positions illustrated in FIG. 9A, it is assumed that the image in which the user gazes at the marker image cannot be used for the gaze detection, that is, the determination unit 224 cannot specify the corneal center of the user. Then, the determination unit 224 transfers that fact to the marker image output unit 223.

The marker image output unit 223 receives that information and corrects the display coordinate position of the marker image displayed when the corneal center of the user cannot be specified to a position close to the center of the screen. That is, as illustrated in FIG. 9B, the display coordinate position of the marker image 901a is corrected to a display coordinate position illustrated in the marker image 901b, the display coordinate position of the marker image 902a is corrected to a display coordinate position illustrated in the marker image 902b, and the display coordinate position of the marker image 903a is corrected to a display coordinate position illustrated in the marker image 903b. Each marker image is displayed at the display coordinate position after correction on the image display element 108 of the head mounted display 100, and an image including the eyes of the user who gazes at the marker image is captured. The determination unit 224 can determine whether or not the corneal center of the user can be specified in the captured image again.

Although the display coordinate positions of the marker images are located closer to the center in both the x-axis direction and the y-axis direction in FIG. 9B, the display coordinate positions of the marker images are corrected to be closer to the center in the direction of only one of the axes. When the corneal center of the user cannot be specified from an image obtained by imaging the user caused to gaze at the marker image of which the display position has been corrected only for one axis, the display coordinate position of the marker image may be additionally corrected to be closer to the center for the other axis.

### <Conclusion>

As described above, the gaze detection system 1 according to the present invention generates the combined image by superimposing the marker image and the image obtained by imaging the eyes of the user gazing at the marker image and outputs the combined image, and therefore, the operator of the gaze detection system 1 can confirm whether or not the user is gazing at the marker image at the time of calibration. Further, to cope with a case in which the cornea of the user creates a shadow on a lower eyelid of the user and the corneal center of the user cannot be specified from the captured image, the gaze detection system 1 corrects the display coordinate position at which the marker image is displayed so that the corneal center of the user can be easily specified.

### Second Embodiment

In the first embodiment described above, the configuration that is significant for the operator of the gaze detection device 200 at the time of calibration for performing the gaze detection has been shown. A configuration in which characteristics of the user 300 can be acquired will be described in the second embodiment. The user 300 who wears and uses the head mounted display 100 has a viewing way and a viewing range different according to an individual difference. Therefore, it is preferable to provide a system that is highly user-friendly by providing an image according to individual characteristics. In the second embodiment, such a gaze detection system will be described.

### <Configuration>

FIG. 11 is a block diagram illustrating a configuration of the gaze detection system according to the second embodiment. As illustrated in FIG. 11, the gaze detection system includes a head mounted display 100 and a gaze detection device 200. As illustrated in FIG. 11, the head mounted display 100 includes a first communication unit 118, a first display unit 121, an infrared light irradiation unit 122, an image processing unit 123, and an imaging unit 124. The gaze detection device 200 includes a second communication unit 220, a gaze detection unit 221, a video output unit 222, a reception unit 228, a specifying unit 229, and a storage unit 227. As illustrated in FIG. 11, the head mounted display 100 and the gaze detection device 200 have the same functions as those of the head mounted display 100 and the gaze detection device 200 illustrated in the first embodiment. In FIG. 11, a configuration that is not related to the second embodiment is omitted. Hereinafter, description of the same functions as in the first embodiment will be omitted and only different functions will be described.

The video output unit 222 transmits a display image of an effective field of view specifying graph to the head mounted display 100 via the second communication unit 220, and the first display unit 121 of the head mounted display 100 displays the transferred effective field of view specifying graph on the image display element 108.

The reception unit 228 of the gaze detection device 200 receives viewing information in the user 300 wearing the head mounted display 100 indicates a way of viewing an object of the user in the effective field of view specifying graph displayed on the image display element 108. The reception unit, for example, may receive the input of the viewing information using an input interface included in or connected to the gaze detection device 200, or may receive the input of the viewing information received through communication from the second communication unit 220. The input interface may be, for example, a hard key of an input panel included in the gaze detection device or may be a keyboard, a touchpad, or the like connected to the gaze detection device 200. The reception unit 228 may also receive an input of voice from the user 300, and in this case, the reception unit 228 may receive the input of the viewing information from the user 300 by analyzing the voice through a so-called voice recognition process. The reception unit 228 transfers the received viewing information to the specifying unit 229.

The effective field of view specifying graph is a display image for specifying an effective field of view of the user 300 wearing and using the head mounted display 100. FIG. 12 illustrates an example of the effective field of view specifying graph. FIG. 12 illustrates a display image 1200 displayed on the image display element 108 of the head mounted display 100.

As illustrated in FIG. 12, the effective field of view specifying graph is an image in which a gaze point marker 1202 indicating a gaze point at which the user gazes, and a plurality of objects annularly arranged around the gaze point marker 1202 are arranged. Here, an example in which Hiragana are arranged as the plurality of respective objects is illustrated, but this can be an example and other characters or images may be arranged. The plurality of objects are images with a size according to a distance from (the center of) the gaze point marker 1202 and are set so that the objects become larger as the distance from the gaze point marker 1202 increases. That is, when a distance between coordinates of a center of the object and coordinates of a center of the gaze point marker is 1 and an image size of the object at that time is x×y, the image size of the object will be 2x×2y in a case in which a distance between center coordinates of the object to be displayed and the coordinates of the center of the gaze point marker 1202 is 21.

The specifying unit 229 specifies an effective field of view of the user 300 on the basis of viewing information transferred from the reception unit 228.

The user 300 specifies objects that the user can clearly view in a state in which the user 300 gazes at the gaze point marker 1202 of the effective field-of-view graph in FIG. 12 displayed on the image display element 108. Information on the object that the user 300 can clearly view while gazing at the gaze point marker 1202 is viewing information in the second embodiment. For example, when an object farthest away from the gaze point marker 1202 in objects clearly viewed by the user is “X, Q, R, S, T, U, V, and W”, a circle 1201 indicated by a dotted line in FIG. 12 becomes the effective field of view of the user 300.

The specifying unit 229 specifies information of the object indicated by the viewing information transferred from the reception unit 228, which is visible to the user 300. The specifying unit 229 specifies an effective field of view range (coordinate range) of the user 300 on the basis of the coordinate system of the effective field-of-view graph that the video output unit 222 transmits to the head mounted display 100, and the display position in the head mounted display 100. Specifically, the specifying unit 229 specifies the display coordinates of the object that the user 300 clearly views while gazing at the gaze point marker, which is indicated by the viewing information. The specifying unit 229 specifies, as the effective field of view of the user, the inside of a circle of which a radius is a distance from the gaze point marker 1202 to coordinates at the farthest position from the gaze point marker 1202 in the display coordinate range of the specified object.

The video output unit 222 generates a high-resolution video on the basis of the effective field of view specified by the specifying unit 229 and the gaze point specified by the gaze detection unit 221. The video output unit 222 generates a high-resolution video of a video portion to be displayed in a range of the effective field of view specified by the specifying unit 229 around the gaze point specified by the gaze detection unit 221. Further, the video output unit 222 generates a low-resolution video corresponding the entire screen. The generated low-resolution video and the high-resolution video in the effective field of view are transmitted to the head mounted display 100 via the second communication unit 220. The video output unit 222 may generate the low-resolution video corresponding to a range outside the effective field of view.

Thus, the gaze detection device 200 can transmit the high-resolution image in a range according to the effective field of view of each user to the head mounted display 100. That is, it is possible to provide the high-resolution image according to vision characteristics of each user. Further, by narrowing down a range in which the high-resolution video is transmitted to the effective field of view of the user, data capacity can be suppressed in comparison with a case in which the high-resolution video corresponding to the entire screen is transmitted. Therefore, it is possible to suppress the amount of data transfer between the head mounted display 100 and the gaze detection device 200. This enables the same effects to be expected, for example, even when the gaze detection device 200 receives a video from an external image distribution server and transfers the video to the head mounted display 100. That is, the gaze detection device 200 specifies a gaze position and an effective field of view of the user and transmits information thereon to the video distribution server, and the video distribution server transmits a high-resolution video in the designated range and a low-resolution image corresponding to the entire screen. Thus, it is possible to suppress a data transfer amount from the video distribution server to the gaze detection device 200.

### <Operation>

FIG. 13 is a flowchart illustrating an operation when the effective field of view of the user by the gaze detection device 200 is specified.

After the gaze detection device 200 performs the calibration illustrated in the first embodiment, the video output unit 222 reads the effective field of view specifying graph from the storage unit 227. The gaze detection device 200 transmits the read effective field of view specifying graph to the head mounted display 100 via the second communication unit 220 together with the display command (step S1301). Accordingly, the first display unit 121 of the head mounted display 100 receives the effective field of view specifying graph through the first communication unit 118 and displays the effective field of view specifying graph on the image display element 108. The user 300 specifies a clearly visible object among the objects displayed around the gazing point marker in a state in which the user 300 gazes at the gaze point marker of the displayed effective field of view specifying graph.

Subsequently, the reception unit 228 of the gaze detection device 200 receives the viewing information which is information of the object that the user 300 views in a state in which the user 300 gazes at the gaze point marker in the displayed effective field of view specifying graph (step S1302). This may be directly input by the user 300 or may be input through transfer of the information on an object viewed by the operator of the gaze detection device 200 from the user 300. Alternatively, a form in which an input indicating whether the user 300 can clearly view the objects in a state in which the respective objects are caused to sequentially blink and the user 300 gazes at the blinking objects may be received by, for example, simply pressing a button at the time of blinking and be input to the reception unit 228 may be adopted. When the reception unit 228 receives the viewing information of the user 300, the reception unit 228 transfers the received viewing information to the specifying unit 229.

If the specifying unit 229 receives the viewing information of the user 300 from the reception unit 228, the specifying unit 229 specifies the effective field of view of the user 300. A method of specifying the effective field of view of the user is as described above. The specifying unit 229 generates information on the specified effective field of view of the user (information indicating a coordinate range centered on the gaze point of the user 300) and stores the information in the storage unit 227 (step S1303), and the process ends.

Through the above-described process, the gaze detection device 200 specifies the effective field of view of the user 300 wearing the head mounted display 100.

Next, a method of using the specified effective field of view will be described. FIG. 14 is a flowchart illustrating an operation when an image to be displayed on the head mounted display 100 is generated on the basis of the effective field of view of the user specified by the gaze detection device 200. The operation illustrated in FIG. 14 is an operation when a video to be displayed on the head mounted display 100 is being transmitted from the gaze detection device 200.

The video output unit 222 generates a video to be displayed on the image display element 108 of the head mounted display 100, which is a low resolution video. The video output unit 222 transmits the generated low-resolution video to the head mounted display 100 via the second communication unit 220 (step S1401).

The second communication unit 220 of the gaze detection device 200 receives a captured image obtained by imaging the eyes of the user viewing the image displayed on the image display element 108 from the head mounted display 100. The second communication unit 220 transfers the received captured image to the gaze detection unit 221. The gaze detection unit 221 specifies the gaze position of the user 300, as illustrated in the first embodiment (step S1402). The gaze detection unit 221 transfers the specified gaze position to the video output unit 222.

If the gaze position of the user 300 is transferred from the gaze detection unit 221, the video output unit 222 reads the effective field of view information indicating the effective field of view of the user 300 specified by the specifying unit 229 from the storage unit 227. The video output unit 222 generates a high-resolution video up to a range of the effective field of view indicated by the effective field of view information, around the transferred gaze position (step S1403).

The video output unit 222 transmits the generated high-resolution video to the head mounted display 100 via the second communication unit 220 (step S1404).

The gaze detection device 200 determines whether or not the video output by the video output unit 222 ends (a last frame is reached) or a video reproduction end input is received from the user 300 or the operator of the gaze detection device 200 (step S1405). When the video does not end or the reproduction end input is not received from the user 300 or the operator (NO in step S1405), the process returns to step S1401. When the video ends or the reproduction end input is received from the user 300 or the operator (YES in step S1405), the process ends.

Thus, the gaze detection device 200 can provide the video without interruption by continuously transmitting the low-resolution video to the head mounted display 100, and can provide a high-resolution image to the user since the gaze detection device 200 also transmits a high-resolution video centered on the gaze point of the user. Further, since the gaze detection device 200 has a configuration of providing the high-resolution image to the head mounted display 100 within the effective field of view of the user 300 and providing the low-resolution image outside the effective field of view, the high resolution image transmitted from the gaze detection device 200 to the head mounted display 100 can be minimized to suppress the amount of transfer of data to be transmitted from the gaze detection device 200 to the head mounted display 100.

### Third Embodiment

In the second embodiment, a scheme of specifying the effective field of view of the user 300 on the basis of a degree of visibility of a plurality of objects according to the distance from the gaze point marker, centered on the gaze point marker, has been described. In the third embodiment of the present invention, a method of specifying the effective field of view of the user 300 in an embodiment different from that of the second embodiment will be described. In the third embodiment, only a difference from the second embodiment will be described.

FIG. 15 illustrates a state in which an effective field-of-view graph according to the third embodiment is displayed on the image display element 108 of the head mounted display 100.

The video output unit 222 causes each circle of the effective field-of-view graph illustrated in FIG. 15 to blink at a predetermined cycle. That is, a non-display from a displayed state and a display from a non-displayed state is repeated at a predetermined cycle. When the user 300 views this state, the circles are not necessarily viewed to be simultaneously displayed and simultaneously disappear due to an individual difference between persons even when all the circles are simultaneously displayed and simultaneously disappear on the system of the head mounted display 100. In the third embodiment, the effective field of view is specified according to a way of viewing the concentric circles different from user to user.

### <Configuration>

The configuration of the gaze detection system according to the third embodiment is the same as the configuration of the gaze detection system illustrated in the second embodiment.

A difference is that the video output unit 222 displays the effective field-of-view graph illustrated in FIG. 12, whereas in the third embodiment, the effective field-of-view graph illustrated in FIG. 15 is displayed to blink. The effective field-of-view graph illustrated in FIG. 15 is an image in which a plurality of concentric circles centered on the center of the gaze point marker are displayed at equal intervals. The respective concentric circles are displayed at equal intervals and with the same line width. The video output unit 222 displays the concentric circle so as to blink at a predetermined cycle. The video output unit 222 displays the circles while changing the predetermined cycle little by little.

The reception unit 228 receives, as the viewing information, information that can specify the information on the cycle when the user feels that all of the concentric circles illustrated in FIG. 15 appear simultaneously and disappear simultaneously.

The specifying unit 229 specifies the effective field of view of the head mounted display 100 on the basis of the cycle indicated by the viewing information transmitted from the reception unit 228. The specifying unit 229 specifies the effective field of view (an effective field of view distance from the gaze point) of the user 300 on the basis of an effective field of view calculation function indicating a relationship between the cycle and the effective field of view, which is stored in the storage unit 227 in advance. The effective field of view calculation function is a function in which the effective field of view of the user 300 is wider (the effective field of view distance is longer) when the cycle is shorter, and the effective field of view of the user 300 is narrowed (the effective field of view is short) when the cycle is longer. That is, in the case of a user with a narrow effective field of view, even when a cycle of switching between the display and the non-display is long, such a change is felt to occur simultaneously. That is, it can be estimated that such a user is generally insensitive to a change in the image. In the case of a user with a large effective field of view, when a cycle between the display and the non-display is long, it is easy to be aware of the change. That is, it can be estimated that such a user is generally sensitive to the image change.

### <Operation>

FIG. 16 is a flowchart illustrating an operation of specifying the field of view of the user 300 in the gaze detection device 200 according to the third embodiment.

As illustrated in FIG. 16, the video output unit 222 displays a plurality of concentric circles to blink at a predetermined cycle (step S1601). That is, in the effective field-of-view graph illustrated in FIG. 15, each circle is displayed so that a non-display from a display and a display from a non-display are repeated simultaneously and at predetermined cycle. For the predetermined cycle, an initial value is given, and the video output unit 222 gradually changes this predetermined cycle.

The user 300 inputs a timing at which all the concentric circles are displayed simultaneously and not displayed simultaneously, as the viewing information, in a process of repeating non-display from a display of a concentric circle group and re-display from non-display while changing the predetermined cycle (step S1602). The reception unit 228 receives this timing and transfers the predetermined cycle in which the video output unit 222 repeats the display/non-display of the concentric circle group at that time to the specifying unit 229.

The specifying unit 229 specifies the effective field of view of the user 300 using the effective field of view function stored in the storage unit 227 from the transferred predetermined cycle (step S1603).

With this configuration, the gaze detection device 200 can specify the effective field of view of the user 300, and achieve the same effects as those illustrated in the second embodiment.

### Fourth Embodiment

In the fourth embodiment, a method of displaying a marker image and a method of detecting a gaze at that time which are different from those of the first embodiment will be described.

The example in which calibration in which nine marker images are displayed in order and the eyes of the user gazing at the nine marker images is imaged is performed has been illustrated in the first embodiment, whereas an example in which calibration is performed with one marker image will be described in the fourth embodiment of the present invention.

### <Configuration>

A basic configuration of the gaze detection system according to this embodiment is the same as the configuration illustrated in the first embodiment. Therefore, the gaze detection system has the same configuration as the block diagram illustrated in FIG. 4. Hereinafter, a difference from the first embodiment will be described.

The video output unit 222 in the fourth embodiment transmits an entire ambient image to the head mounted display 100 at the time of calibration. In this case, the entire ambient image (or an image wider than a range that is wide to some extent, that is, the display range of the image display element 108) includes at least one marker image. That is, the first display unit 121 of the head mounted display 100 displays the marker image at predetermined coordinates in the world coordinate system. The world coordinates refer to a coordinate system representing the entire space when the image is three-dimensionally displayed. Further, the entire ambient image is basically a 360° image to be displayed in the world coordinate system. Since the head mounted display 100 can specify a direction to which the user is directed by including the acceleration sensor, the video output unit 222 receives information on the acceleration sensor from the head mounted display 100 to determine in which range the image is transferred and transfers the image data.

The user 300 moves the head of the user in a state in which the user 300 wears the head mounted display 100 so that the marker image is displayed to be included in the display range of the head mounted display 100, and gazes at the marker image from at least two different directions at this time. The camera 116 of the head mounted display 100 images the eyes of the user at that time and acquires an image for calibration. That is, in the first embodiment, the marker images are displayed at the nine positions to be a different positional relationship between the eye of the user and the marker image and the user is caused to gaze at the marker image, whereas in the fourth embodiment, there is only one marker image to be displayed, but the user views this marker image from various angles, making it possible to acquire a plurality of images for calibration.

FIGS. 17A and 17B are diagrams schematically illustrating a correspondence relationship between the entire ambient image and the display screen displayed on the head mounted display 100. FIGS. 17(a) and 17B illustrate a state in which the user 300 is wearing the head mounted display 100, and are diagrams schematically illustrating the display range 1702 displayed on the image display element 108 of the head mounted display 100 and a marker image 1703 in the entire ambient image 1701 with respect to the entire ambient image 1701 transmitted from the gaze detection device 200 at this time. The entire ambient image 1701, the display range 1702, or the marker image 1703 illustrated in FIGS. 17(a) and 17B is a virtual image or range, and it should be noted that the image or range is not the image or range actually appearing as in FIGS. 17(a) and 17B. A position at the world coordinates of the marker image 1703 is fixed. On the other hand, when the marker image 1703 is displayed on the image display element 108, the display position is different according to a direction of a face of the user 300. The marker image 1703 is mark, and it is understood that a shape thereof is not limited to a circular shape.

FIG. 17A illustrates a state in which the marker image 1703 is not included in the display range 1702 of the display image element of the head mounted display 100. FIG. 17B illustrates a state in which the marker image 1703 is included in the display range 1702. In the state of FIG. 17B, the camera 116 of the head mounted display 100 images the eyes of the user using near-infrared light as a light source. Further, the user 300 moves his or her own head to move the display range 1702 so that a marker image 1703 appears at a position different from the position illustrated in FIG. 17B within the display range 1702, and gazes at the marker image in this case. The camera 116 of the head mounted display 100 similarly images the eyes of the user. In the fourth embodiment, a plurality of images for calibration can be obtained in this manner, and the gaze point of the user can be specified using each equation illustrated in the first embodiment.

Therefore, the marker image output unit 223 according to the fourth embodiment has a function of determining the display position of the marker image in the world coordinate system.

### <Operation>

An operation of the gaze detection system according to the fourth embodiment will be described using a flowchart illustrated in FIG. 8.

As illustrated in FIG. 18, the marker image output unit 223 determines the display coordinates of the marker image in the world coordinate system (step S1801).

The video output unit 222 of the gaze detection device 200 transmits an image to be displayed on the image display element 108 via the second communication unit 220. The marker image output unit 223 similarly transmits the marker image together with display coordinates thereof to the head mounted display 100. The first display unit 121 of the head mounted display 100 detects a direction for the world coordinate system of the head mounted display 100 from a value of the acceleration sensor mounted on the head mounted display 100 and determines whether or not an image in the direction, which is the marker image, is included within the range displayed on the image display element 108 (step S1802).

When the marker image is included in the display range (YES in step S1802), the first display unit 121 displays the marker image at a corresponding position on the image display element 108 (step S1803). When the marker image is not included in the display range (NO in step S1803), the process proceeds to step S1805.

The camera 116 images the eyes of the user 300 gazing at the marker image displayed on the image display element 108 using invisible light as a light source (step S1804). The head mounted display 100 transmits the captured image to the gaze detection device 200, and the gaze detection device 200 stores the captured image in the storage unit 227 as an image for the calibration.

The gaze detection unit 221 of the gaze detection device 200 determines whether or not the number of the captured images required for calibration reaches a predetermined number (for example, nine, but the number is not limited thereto) (step S1805). When the number of the captured images reaches the predetermined number (YES in step S1805), a process of the calibration ends (step S1805). On the other hand, when the number of the captured images does not reach the predetermined number (NO in step S1805), the process returns to step S1802.

Thus, it is also possible to perform the calibration for gaze detection, as in the first embodiment. The calibration in the fourth embodiment may be performed, for example, during loading of the next image in discontinuity between a video and a video or may be generally performed in a loading screen of a game. Further, in this case, the marker image may be moved and the user may be caused to gaze at the moving marker image. In this case, the marker image may be an image of a character appearing in an viewed image, an executed game, or the like.

### <Supplement 1>

The gaze detection system according to the present invention may be configured as follows.

(a) A gaze detection system may be a gaze detection system that includes a video display device that is mounted on a head of a user and used, the gaze detection system including a display screen that displays a video to be present to a user, a display unit that displays an object on the display screen to spread in an annular shape around a predetermined display position of the display screen, a reception unit that receives viewing information indicating a way of viewing the object in the user in a state in which the user gazes at the predetermined display position, and a specifying unit that specifies an effective field of view of the user on the basis of the viewing information.

(b) Further, in the gaze detection system described in (a), the display unit may display an object having a size according to a distance from the predetermined display position around the predetermined display position, and the viewing information may be information indicating a range in which the user can clearly view the object in a state in which the user gazes at the predetermined display position.

(c) Further, in the gaze detection system described in (a), the display unit may display a plurality of circles centered on the predetermined display position to blink at a predetermined distance interval and at a predetermined cycle, and the viewing information may be information from which the predetermined cycle that can be recognized by the user can be specified when the plurality of blinking circles are simultaneously displayed or disappear in a state in which the user gazes at the predetermined display position.

(d) Further, in the gaze detection system according to any one of (a) to (c), the gaze detection system may further include a gaze detection unit that detects a gaze position when the user views an image displayed on the display screen, and the display unit may display a high resolution images within the effective field of view specified by the specifying unit around the gaze position, and display the low resolution image outside the effective field of view.

(e) Further, in the gaze detection system described in (d), the image display device may be a head mounted display, and the gaze detection system may generate an image to be displayed on the display screen provided in the head mounted display and transfer the image to the head mounted display, and may include a video generation unit that generates and transfers a high resolution image to be displayed within the effective field of view specified by the specifying unit around the gaze position and generates and transfers a low resolution image to be displayed at least outside the effective field of view.

(f) Further, in the gaze detection system according to (e), the video generation unit may generate and transfer a low-resolution image of the entire display image irrespective of the position of the effective field of view.

(g) Further, a gaze detection system includes a video display device that is mounted on a head of a user and used, and includes a display screen that displays an image to be present to the user, a display unit that displays a marker image arranged at a specific coordinate position on a world coordinate system when the specific coordinate position is included in a display coordinate system of the display screen, an imaging unit that images the eyes of the user in a state in which the user gazes at the marker image when the marker image is displayed on the display screen, and a gaze detection unit that detects the gaze position of the user on the display screen on the basis of at least two different captured images captured by the imaging unit.

(h) Further, the effective field of view specifying method according to the present invention is an effective field of view specifying method for the user in a gaze detection system including a video display device that is mounted on a head of a user and used and has a display screen that displays an image to be present to the user, the effective field of view specifying method including a display step of displaying the object on the display screen to spread in an annular shape around a predetermined display position of the display screen, a reception step of receiving viewing information indicating a way of viewing the object in the user in a state in which the user gazes at the predetermined display position, and a specifying step of specifying an effective field of view of the user on the basis of the viewing information.

(i) Further, a gaze detection method according to the present invention is a gaze detection method in a gaze detection system including a video display device that is mounted on a head of a user and used and has a display screen that displays an image to be present to the user, the gaze detection method including a display step of displaying a marker image arranged at a specific coordinate position on a world coordinate system on the display screen when the specific coordinate position is included in a display coordinate system of the display screen, an imaging step of imaging the eyes of the user in a state in which the user gazes at the marker image when the marker image is displayed on the display screen, and a gaze detection step of detecting the gaze position of the user on the display screen on the basis of at least two different captured images captured in the imaging step.

(j) Further, an effective field of view specifying program according to the present invention causes a computer included in a gaze detection system including a video display device that is mounted on a head of a user and used and has a display screen that displays an image to be present to the user, to realize a display function of displaying an object on the display screen to spread in an annular shape around a predetermined display position of the display screen, a reception function of receiving viewing information indicating a way of viewing the object in the user in a state in which the user gazes at the predetermined display position, and a specifying function of specifying an effective field of view of the user on the basis of the viewing information.

(k) A gaze detection program according to the present invention causes a computer included in a gaze detection system including a video display device that is mounted on a head of a user and used and has a display screen that displays an image to be present to the user, to realize a display function of displaying a marker image arranged at a specific coordinate position on a world coordinate system on the display screen when the specific coordinate position is included in a display coordinate system of the display screen, an imaging function of imaging the eyes of the user in a state in which the user gazes at the marker image when the marker image is displayed on the display screen, and a gaze detection function of detecting the gaze position of the user on the display screen on the basis of at least two different captured images captured in the imaging function.

### Fifth Embodiment

Various schemes related to the calibration have been described in the above-described embodiment, whereas a scheme of reducing fatigue of the user will be described in this embodiment. Therefore, this fatigue will first be described.

There is a head mounted display that displays a three-dimensional video. Incidentally, there is a problem in that a user may feel fatigued when viewing the three-dimensional video. When a three-dimensional image is displayed, the displayed object is viewed to stand out relative to an actual monitor position by the user. Therefore, the eyeball of the user aligns a focal point with the display position (depth) of the displayed object. However, since a position of the monitor is behind the display position of the displayed object in reality, the eyeballs notice that there is an actual monitor in such a position, and the focal point is attempted to be aligned with that position again. When the three-dimensional image is viewed, automatic focusing of the eyeballs alternately occurs, and therefore, the user feels fatigued.

Therefore, a gaze detection system that can reduce the fatigue of the user when stereoscopic vision is performed is disclosed in the fifth embodiment.

### <Configuration>

FIG. 19 is a block diagram of the head mounted display 100 and the gaze detection device 200 according to the gaze detection system 1. The gaze detection system is referred to as a stereoscopic video display system in this embodiment. As illustrated in FIG. 19 and as described above, the gaze detection system 1 includes the head mounted display 100 and the gaze detection device 200 that communicate with each other. Here, a configuration different from in the above embodiment will be described.

As illustrated in FIG. 19, the head mounted display 100 includes a first communication unit 118, a display unit 121, an infrared light irradiation unit 122, an image processing unit 123, an imaging unit 124, a driving unit 125, and a driving control unit 126.

The first communication unit 118 transfers three-dimensional video data to the driving control unit 126, in addition to the various functions described in the above embodiment. Information indicating a display depth of a object to be displayed is included in three-dimensional video data. Here, the display depth is a distance from the eyes of the user to a display position at which an object is in a pseudo manner displayed by stereoscopic vision. Further, the three-dimensional video data includes a parallax image for the right eye and a parallax images for the left eye, which are a parallax image pair.

The driving unit 125 has a function of driving a motor for moving the image display element 108 so that a relative distance between the image display element 108 and the eyes of the user changes according to a control signal transferred from the driving control unit 126.

The driving control unit 126 has a function of generating a control signal for moving the image display element 108 according to the display depth of the displayed object using the image data transferred from the first communication unit 118, and transferring the control signal to the driving unit 125. The driving control unit 126 generates the control signal according to the following driving examples as a scheme of generating a control signal.

### Driving Example 1

If a difference between the display depth of the displayed object to be displayed and the depth of the image display element 108 is equal to or greater than a predetermined threshold value, a control signal is generated to cause the depth of the image display element 108 to approach the display depth. Here, the control signal is generated if the difference is equal to or greater than the predetermined threshold value, but the control signal may be generated to cause the depth of the image display element 108 to approach the display depth of the object without performing this comparison.

### Driving Example 2

A first display depth of the displayed object displayed at a first time is compared with a second display depth of the displayed object displayed at a second time, and if the second display depth is larger than the first display depth, the displayed object displayed at the second time is displayed on the far side when viewed from the user 300 than the displayed object displayed at the first time.

An operation of the driving unit will be described in greater detail below.

FIGS. 20A and 20B are views illustrating an example of a mechanism for moving the image display element 108, that is, the monitor. FIG. 20A is a plan view illustrating the driving unit of the image display element 108 of the head mounted display 100 and is a view illustrating a mechanism inside the head mounted display 100. FIG. 20B is a perspective view of the driving unit viewed from diagonally below in a direction indicated by an arrow 711 in FIG. 20A.

As illustrated in FIGS. 20A and 20B, an end portion (right side in the drawing) of the image display element 108 is connected to a fulcrum 701, and the fulcrum 701 is fixed to a rail 702 so that an end portion thereof is slidable. A comb tooth is provided at the end portion of the image display element 108 and fitted to a teeth of a belt lane 703. A tooth is provided on the surface of the belt lane 703, as illustrated in FIGS. 20A and 20B, and the tooth is moved due to the rotation of the motor 704. Accordingly, the image display element 108 also moves in a direction indicated by an arrow 710. When the motor 704 rotates clockwise, the image display element 108 moves in a direction away from the eyes of the user 300, and when the motor 704 rotates counterclockwise, the image display element 108 moves in a direction approaching the eyes of the user 300. Here, the motor 704 is rotated by the driving unit 125 according to the control from the driving control unit 126. For example, by having such a structure, the image display element 108 of the head mounted display 100 can move so that the relative distance to the eyes of the user 300 is changed. A scheme of moving the image display element 108 is only one example, and it is understood that the moment may be realized using another scheme.

### <Operation>

Hereinafter, a driving method of moving the image display element 108 in the head mounted display 100 will be described.

### Driving Example 1

FIG. 21 is a flowchart illustrating an operation of the head mounted display 100 according to the embodiment.

The video output unit 222 of the gaze detection device 200 transfers video data of a stereoscopic video that is displayed on the image display element 108 to the second communication unit 220. The second communication unit 220 transmits the transferred video data to the head mounted display 100.

When the first communication unit 118 receives the video data, the first communication unit 118 transfers the video data to the driving control unit 126. The driving control unit 126 extracts display depth information of the displayed object from the transferred video data (step S2101).

The driving control unit 126 determines whether or not the distance between the display depth indicated by the extracted display depth information and the depth determined from the position of the image display element 108 is equal to or larger than a predetermined threshold value (step S2102). That is, the driving control unit 126 determines whether or not the distance between the displayed object and the image display element 108 is separated by a certain distance or more. When the driving control unit 126 determines that the distance between the display depth and the image display element 108 is equal to or greater than the predetermined threshold value (YES in step S2102), the process proceeds to step S2103. When the driving control unit 126 determines that is smaller than the predetermined threshold value (NO in step S2102), the process proceeds to step S2104.

The driving control unit 126 specifies the display depth at which the displayed object is reflected in the eyes of the user from the extracted display depth information. The driving control unit 126 generates a control signal for moving the monitor, that is, the image display element 108 in a direction approaching the specified display depth and transfers the control signal to the driving unit 125. The driving unit 125 drives the motor 704 to move the image display element 108 on the basis of the transferred control signal (step S2103). The driving unit 125 transfers the fact that the image display element 108 has been moved, to the display unit 121.

When the fact that the image display element 108 has been moved is transferred from the driving unit 125, the display unit 121 causes a corresponding video to be displayed on the image display element 108 (step S2104).

By repeating the process illustrated in FIG. 21, the image display element 108 can be moved each time according to the display depth of the object to be displayed. That is, a difference between the display depth of the object and the position of the image display element 108 can be reduced. Accordingly, it is possible to suppress occurrence of focal point adjustment through eyeball movement of the user 300. This makes it possible to suppress the fatigue of the user 300.

### Driving Example 2

FIG. 22 is a flowchart illustrating details of the operation of the head mounted display 100 according to the embodiment. Description will be give herein starting with a stage in which image data that is image data for a moving image is transferred to the driving control unit 126.

The driving control unit 126 extracts the display depth information (hereinafter referred to as “first display depth information”) of the displayed object to be displayed at the first time in the video data from the video data (step S2201).

Then, the driving control unit 126 extracts the display depth information (hereinafter referred to as second display depth information) of the displayed object to be displayed at the second time following the first time in the video data from the video data (step S2202). Here, the second time does not need to be immediately after the first time (after 1 frame) and may be after a certain time (for example, 1 sec).

The driving control unit 126 determines whether or not the second display depth indicated by the second display depth information is larger (deeper) than the first display depth indicated by the first display depth information (step S2203). This is synonymous with determining whether or not the object displayed at the second time is displayed on the back side and viewed for the user in comparison with a case in which the object is displayed at the first time.

When the second display depth is larger than the first display depth (YES in step S2203), the driving control unit 126 transfers a control signal to the driving unit 125 to move the image display element 108, that is, the monitor in a direction away from the eyes of the user. The driving unit 125 moves the image display element 108 in a direction away from the eyes of the user according to the control signal (step S2204).

When the second display depth is smaller than the first display depth (NO in step S2203), the driving control unit 126 transfers the control signal to the driving unit 125 to move the image display element 108, that is, the monitor in a direction approaching the eyes of the user. The driving unit 125 moves the image display element in the direction approaching the eyes of the user according to the control signal (step S2206).

When the driving unit 125 moves the image display element 108, the driving unit 125 transfers to the display unit 121 that the driving unit 125 has moved the image display element 108. The display unit 121 displays the image to be displayed at the second time on the image display element 108 (step S2205).

The head mounted display 100 repeats the process illustrated in FIG. 22 until all of the video data output from the video output unit 222 of the gaze detection device 200 is displayed (or reproduction of the video is stopped by the user).

Accordingly, when the distance between the display depth of the object and the image display element 108 in the case of a moving image in which images are continuously displayed fluctuates, it is easy for a focal point adjustment function of the user 300 to occur, but a frequency of this occurrence can be suppressed through the process illustrated in FIG. 22.

### <Conclusion>

As described above, the gaze detection system 1 according to the present invention can move the image display element 108, that is, the monitor according to the display depth of the object in the displayed stereoscopic video. Specifically, it is possible to cause the position of the image display element 108 to be close to the display depth of the stereoscopic video. When the difference between the position of the image display element 108 and the display depth of the stereoscopic video is greater, focal point adjustment of eyeballs is likely to occur, but the head mounted display 100 can suppress a frequency of generation of eyeball focal point adjustment movement by including the configuration according to this embodiment. Accordingly, since the occurrence of focal point adjustment of an eyeball function can be slightly reduced on the basis of the difference between the virtual display position of the object and the actual position of the monitor, it is possible to suppress eyeball fatigue of the user.

Further, when the gaze detection system 1 according to the present invention is mounted on the head mounted display 100 and used, it is easy to move the monitor, and it is also possible to perform the gaze detection. Accordingly, it is possible to present a stereoscopic video without the user feeling fatigued as much as possible and to realize both gaze detections capable of specifying a point that the user is viewing in the stereoscopic video.

In the fifth embodiment, a structure for operating the image display element 108 is not limited to the structure illustrated in FIGS. 20A and 20B. Another structure may be adopted as long as the structure is a structure in which the image display element 108 can be moved in a direction indicated by the arrow 710 in FIG. 20A. For example, the same structure may be realized by a worm gear or the like. Further, although the structure illustrated in FIGS. 20A and 20B is included on the left and right sides of the head mounted display 100 (left and right in a state in which the user wears the head mounted display 100, and left and right in a longitudinal direction of the image display element 108) in the above embodiment, the structure only on one side may be adopted as long as the structure can move the image display element 108 to the left and right without causing uncomfortable feeling.

In the fifth embodiment, the number of the image display elements 108 is one, but the number is not limited thereto. Two image display elements including an image display element corresponding to the left eye of the user 300 and an image display element corresponding to the right eye of the user 300 may be included in the head mounted display 100 and may be separately driven. Accordingly, fine control such as focal point adjustment according to vision of the left and right eyes of the user 300 can be performed.

Although the image reflected by the hot mirror 112 is captured as a scheme of imaging the eyes of the user 300 in order to detect the gaze of the user 300 in the fifth embodiment, the eyes of the user 300 may be directly imaged without passing through the hot mirror 112.

### <Supplement 2>

The gaze detection system according to the fifth embodiment may be expressed as a stereoscopic video display system as follows.

(l) The stereoscopic video display system according to the fifth embodiment is a stereoscopic video display system including a monitor that displays a stereoscopic video to be presented to a user, a driving unit that moves the monitor so that the relative distance with the eyes of the user changes, and a control unit that controls the driving unit according to the depth of stereoscopic video to be displayed on the monitor.

Further, the control method according to the fifth embodiment is a control method of a stereoscopic video display system for reducing the fatigue of a user in stereoscopic vision, the method including a display step of displaying a stereoscopic video to be presented to a user on a monitor, and a control step of controlling the driving unit to move the monitor so that the relative distance to the eyes of the user changes according to the depth of the stereoscopic video to be displayed on the monitor.

The control program according to the fifth embodiment is a program that causes a computer of the stereoscopic video display system to execute a display function of displaying a stereoscopic video to be presented to a user on the monitor, and a control function of controlling the driving unit that moves the monitor so that a relative distance to the eyes of the user changes according to the depth of the stereoscopic video to be displayed on the monitor.

(m) In the stereoscopic video display system according to (l), the control unit may control the driving unit in a direction approaching the monitor to the depth at which the stereoscopic video is displayed.

(n) In the stereoscopic video display system according to (l) or (m), the control unit may control the driving unit to move the monitor in a direction approaching the eyes of the user when the depth of the stereoscopic video displayed at the second time following the first time is smaller than the depth of the stereoscopic video displayed at the first time.

(o) In the stereoscopic video display system according to any one of (l) to (n), the control unit may control the driving unit to move the monitor in a direction away from the eyes of the user when the depth of the stereoscopic video displayed at the second time following the first time is greater than the depth of the stereoscopic video displayed at the first time.

(p) In the stereoscopic video display system according to any one of (l) to (o), the three-dimensional video display system may be mounted on the head mounted display that is mounted on the head of the user and used by the user, and the head mounted display may further include an invisible light irradiation unit that irradiates the eyes of the user with invisible light, an imaging units that images the eyes of the user including the invisible light irradiated by the invisible light irradiation unit, and an output unit that outputs the image captured by the imaging unit to the gaze detection device that performs gaze detection.

### <Supplement 3>

The gaze detection system according to the present invention is not limited to the above-described embodiment, and it is understood that gaze the detection system can be realized by another scheme for realizing the idea of the present invention.

In the embodiment, the positions at which the marker images (bright spots) are displayed is one example, and it is understood that the positions are not limited to the display position illustrated in the above embodiment as long as the marker images can be displayed at different positions in order to perform detection of the gaze of the user, an image of the eyes of the user gazing at each of the marker images can be acquired, and the center of the eyes of the user at that time can be specified. Further, the number of marker images to be displayed at that time is limited to nine. Since four equations may be established to specify four elements of the matrix x, it is sufficient to specify the corneal center of the user for at least marker images of four points.

Although the image reflected by the hot mirror 112 is captured as a scheme of imaging the eyes of the user 300 in order to detect the gaze of the user 300 in the above embodiment, the eyes of the user 300 may be directly imaged without passing through the hot mirror 112.

Although the marker image output unit 223 changes the display position of the marker image according to the input instruction from the operator of the gaze detection device 200 in the above embodiment, the marker image output unit 223 may automatically change the display position of the marker image. For example, the marker image output unit 223 may change the display position of the marker image each time a predetermined time (for example, 3 seconds) has elapsed.

More preferably, the gaze detection system 1 may be configured to analyze the captured image obtained from the head mounted display 100, determine whether or not the user gazes at the marker image, and change the display position of the marker image when determining that the user gazes at the marker image.

That is, the storage unit 227 stores an image in a state in which the user gazes at the center of the image display element 108 (an image captured in a state in which the user is gazing at a marker image at a center among the nine marker images) in advance. The determination unit 224 compares a center position of the cornea (black eye) of the stored image with a center position of the cornea of the captured image, and determines whether or not the user gazes at the marker image according to whether or not the corneal center of the user of the captured image is separated by a predetermined distance (for example, 30 pixels in a pixel coordinate unit system of the image display element 108) or more in a direction in which the marker image is displayed, from the corneal center of the user of the stored image. When the determination unit 224 determines in the determination that the user gazes at the marker image, the determination unit 224 instructs the marker image output unit 223 to change the display position of the marker image, and the marker image output unit 223 changes the display position of the marker image according to the instruction.

When it is determined that the user does not gaze at the marker image, the marker image output unit 223 can report the fact so that the marker image is emphatically displayed (for example, the marker image blinks at the display position thereof, the marker image is indicated by an icon such as an arrow, or a text with content such as “Look at the marker” is displayed), such that the user can pay attention to the marker image. This report may be realized by announcing “Please look at the marker” from the headphone 170 of the head mounted display 100 through voice guidance. Therefore, the storage unit 227 stores data of the sound, and when the marker image output unit 223 determines that the user is not gazing at the marker image, the marker image output unit 223 transmits the data of the sound to the head mounted display 100. The head mounted display 100 outputs the received data of sound from the headphone 170. Further, when the determination unit 224 determines that the acquisition of the captured image for calibration is successful, the head mounted display 100 may display, for example, an image such as “O” or “OK” on the marker image to show to the user that there has been no problem (show that the calibration is successful).

Thus, by constituting the gaze detection system 1 to determine whether or not the user wearing the head mounted display 100 gazes at the marker image, it is possible to realize automation of the calibration. Accordingly, the calibration can be performed without an operator although an operator is required separately from the user wearing the head mounted display 100 in the calibration of the related art.

Further, the head mounted display 100 may have a configuration in which a distance between the image display element 108 and the eyes of the user can be changed (moved) when displaying a 3D image. When a virtual distance (depth) from the eyes of the user to the displayed 3D image and an actual distance between the eyes of the user and the image display element 108 are different, this is a cause of fatigue of the eyes of the user. With the configuration, the head mounted display 100 can reduce the fatigue of the eyes of the user.

Further, in the gaze detection system 1, the effective field of view of the user may be specified at the time of calibration. The effective field of view of the user is a range in which the user can clearly recognize the image toward an end portion from a certain point is a state in which the user is looking at the certain point. In the gaze detection system 1, the marker image may be displayed circularly from a center of the screen at the time of calibration and the effective field of view may be specified. Further, the effective field of view of the user may be specified by specifying a cycle serving as a timing at which a plurality of concentric circles centered on a certain point are caused to be displayed to blink and simultaneously disappear in a state in which the user is looking at the certain point. If the effective field of view can be specified for each user, it is difficult for the user to recognize the image outside the effective field of view even when image quality is lowered. Therefore, it is possible to suppress the data transfer amount of the image transferred from the gaze detection device 200 to the head mounted display 100.

Further, although the processor of the gaze detection device 200 executes the gaze detection program or the like to specify the point at which the user gazes as a method of the calibration in the gaze detection in the above embodiment, this may be realized by a logical circuit (hardware) including an integrated circuit (an integrated circuit (IC) chip, large scale integration (LSI), or the like) or the like) or a dedicated circuit in the gaze detection device 200. Further, the circuit may be realized by one or a plurality of integrated circuits, or the functions of the plurality of functional units illustrated in the above embodiment may be realized by a single integrated circuit. The LSI may be called VLSI, super LSI, ultra LSI, or the like according to an integration difference. That is, as illustrated in FIG. 10, the head mounted display 100 includes a first communication circuit 118a, a first display circuit 121a, an infrared light irradiation circuit 122a, an image processing circuit 123a, and an imaging circuit 124a, and each function is the same as that of each unit having the same name illustrated in the above embodiment. Further, the gaze detection device 200 may include a second communication circuit 220a, a gaze detection circuit 221a, a video output circuit 222a, a marker image output circuit 223a, a determination circuit 224a, a combined image output circuit 225a, a second display circuit 226a, and a storage circuit 227a, and each function is the same as that of each unit having the same name illustrated in the above embodiment. Although an example in which the gaze detection system in the first embodiment is realized by a circuit has been illustrated in FIG. 10, it is understood that the gaze detection system illustrated in FIG. 11 or 19 may be similarly realized by a circuit, which is not illustrated.

Further, the gaze detection program may be recorded on a processor-readable recording medium, and the recording medium may be a “non-transitory tangible medium” such as a tape, a disk, a card, a semiconductor memory, or a programmable logic circuit. Further, the gaze detection program may be supplied to the processor through an arbitrary transmission medium (such as a communication network or broadcast waves) capable of transmitting the gaze detection program. The present invention can also be realized in the form of a data signal embodied in a carrier wave, in which the gaze detection program is implemented by electronic transmission.

For example, the gaze detection program may be installed using, for example, a script language such as ActionScript or JavaScript (registered trademark), an object-oriented programming language such as Objective-C or Java (registered trademark), or a markup language such as HTML5.

Further, the gaze detection method according to the present invention may be a method of detecting gaze using a gaze detection system including a head mounted display that is mounted on and used by a user and a gaze detection device that detects the gaze of the user, wherein the gaze detection device outputs the marker image to the head mounted display, the head mounted display displays the marker image, images the eyes of the user gazing at the marker image, and outputs the captured image including the eyes of the user to the gaze detection device, and the gaze detection device creates a combined image obtained by superimposing the marker image and the image including the eyes of the user gazing at the captured marker image and outputs the created combined image.

Further, the gaze detection program according to the present invention may be a program that causes a computer to realize a marker image output function of outputting a marker image to be displayed on the head mounted display, an acquisition function of acquiring a captured image obtained by imaging the eyes of the user gazing at the marker image displayed on the head mounted display, a creation function of creating a combined image obtained by superimposing the marker image and the captured image, and a combined image output function of outputting the combined image.

The present invention can be used in a head mounted display.

What is claimed is:

1. A gaze detection system comprising a head mounted display that is worn and used by a user, and a gaze detection device that detects gaze of the user,
wherein the head mounted display includes
a display unit that displays an image;
an imaging unit that images eyes of the user; and
an image output unit that outputs an image including the eyes of the user captured by the imaging unit to the gaze detection device, and
the gaze detection device includes
a marker image output unit that outputs a marker image to be displayed on the display unit;
a combined image creation unit that creates a combined image obtained by superimposing the marker image output by the marker image output unit and an image including the eyes of the user gazing at the marker image captured by the imaging unit; and
a combined image output unit that outputs the combined image.

2. The gaze detection system according to claim 1,
wherein the marker image output unit sequentially changes a display position of the marker image and outputs the marker image, and
the imaging unit images the eyes of the user gazing at the marker image each time at least the display position is changed.

3. The gaze detection system according to claim 2,
wherein the marker image output unit changes the display position of the marker image to any one of a plurality of predetermined coordinate positions and outputs the marker image, and
the gaze detection device further includes a gaze detection unit that detects a gaze direction of the user on the basis of the image of the eyes of the user captured by the imaging unit and each image including the eyes of the user gazing at the marker image for each display position.

4. The gaze detection system according to claim 3, further comprising:
a determination unit that determines whether or not the image including the eyes of the user gazing at the marker image is usable as an image for gaze detection in the gaze detection unit,
wherein, when the determination unit determines that the image is not usable as an image for gaze detection, the marker image output unit changes a display position of the marker image displayed when the image corresponding to the determination is captured to a position close to a center of the display unit and causes the marker image to be displayed,
the imaging unit images the eyes of the user gazing at the marker image of which the display position has been changed, and
the determination unit determines whether or not that a comparative image captured again is usable as an image for gaze detection.

5. The gaze detection system according to claim 4,
wherein the determination unit further determines whether or not the user is gazing at the displayed marker image on the basis of the image of the eyes of the user captured by the imaging unit, and
the gaze detection system further comprises a reporting unit that performs reporting to cause the user to gaze at the marker image when it is determined that the user is not gazing at the marker image.

6. The gaze detection system according to claim 5,
wherein the marker image output unit changes the display position of the marker image when the determination unit determines that the user is gazing at the displayed marker image.
